(19) United States
(12) Patent Application Publication
(10) Pub. No.: US 2020/0356735 A1
(43) Pub. Date: Nov. 12, 2020

(54) APPARATUS AND METHOD OF DETECTING PRODUCT LABEL REMOVAL USING RFID TAG DEVICES

(71) Applicant: Walmart Apollo, LLC, Bentonville, AR (US)

(72) Inventor: Bruce W. Wilkinson, Rogers, AR (US)

(21) Appl. No.: 16/866,999

(22) Filed: May 5, 2020

Related U.S. Application Data
(60) Provisional application No. 62/843,750, filed on May 6, 2019.

(51) Int. Cl. G06K 7/10; G06K 19/077

(52) U.S. Cl. CPC G06K 7/10178; G06K 19/07749; G06K 7/10366; G06K 7/10108

(57) ABSTRACT

Methods, systems, and apparatuses are provided using RFID devices to assist in detecting retail product label removal. For example, a system includes a product identifier including a base substrate, a first RFID tag device, a second RFID tag device, a metallic substrate, a first attachment mechanism, and a second attachment mechanism. By one approach, the first attachment mechanism is configured to fail with an application of a lower separation force than the second attachment mechanism, such that upon an action causing a separation force to separate the base substrate from a first retail product will cause the first attachment mechanism to fail such that the base substrate will be removed from the metallic substrate and the first retail product. In some embodiments, upon this separation and removal, the second RFID tag device will then be readable by the RFID tag reader.

### CROSS-REFERENCE TO RELATED APPLICATION

This application claims the benefit of U.S. Provisional Application No. 62/843,750 filed May 6, 2019, which is incorporated herein by reference in its entirety.

### TECHNICAL FIELD

This invention relates generally to radio-frequency identification (RFID) transceivers.

### BACKGROUND

RFID tags are known in the art. These so-called tags often assume the form factor of a label or a literal “tag” but are also sometimes integrated with a host article and/or its packaging. RFID tags typically comprise an integrated circuit and one or more antennas. The integrated circuit typically carries out a variety of functions including modulating and demodulating radio frequency signals, data storage, and data processing. Some integrated circuits are active or self-powered (in whole or in part) while others are passive, being completely dependent upon an external power source (such as an RFID tag reader) to support their occasional functionality.

There are proposals to utilize RFID tags to individually identify individual items. The Electronic Product Code (EPC) as managed by EPCGlobal, Inc. represents one such effort in these regards. EPC-based RFID tags each have a unique serial number to thereby uniquely identify each tag and, by association, each item correlated on a one-for-one basis with such tags. (The corresponding document entitled EPC Radio-Frequency Identity Protocols Class-1 Generation-2 UHF RFID Protocol for Communications at 860 MHz-960 MHz Version 1.0.9 is hereby fully incorporated herein by this reference.)

RFID readers are devices that attempt to read any RFID tags within range of the reader. Typically, the RFID reader transmits electromagnetic energy through free space to any tags within range. The energy is received at any RFID tag in range, modulated with identification or other data stored in the RFID tag, and backscattered by the RFID tag back the reader. The RFID reader receives the backscattered energy and demodulates the energy to recover the data. In other forms, the RFID reader induces a response within the RFID tag using electromagnetic force, the induced response is then modulated with the data of the RFID tag which then induces a corresponding response back in the RFID reader which demodulates the response to recover the data. The data recovered by the RFID reader is then processed in accordance with the purpose of the reading.

### BRIEF DESCRIPTION OF THE DRAWINGS

Disclosed herein are embodiments of apparatuses and methods pertaining to the use of RFID tags and readers to automatically make certain determinations, e.g., to determine an open status of a sealed container. This description includes drawings, wherein:

FIG. 1 is a block diagram in accordance with several embodiments;

FIG. 2 is a block diagram in accordance with several embodiments;

FIGS. 3A-3D are diagrams illustrating an application in accordance with several embodiments;

FIGS. 4A-4B are diagrams illustrating an application in accordance with several embodiments;

FIG. 4C is an illustration of a near field RFID device in accordance with several embodiments;

FIG. 5 is a diagram illustrating application in accordance with several embodiments;

FIG. 6 is a diagram of a multi-tag RFID device in accordance with several embodiments;

FIG. 7 is a diagram illustrating an application using a multi-tag RFID device in accordance with several embodiments;

FIG. 8 is a flow diagram of a method in accordance with several embodiments;

FIGS. 9A-9C are illustrations of a container in accordance with several embodiments;

FIGS. 10A-10C are illustrations of another container in accordance with several embodiments;

FIG. 11 is a variation of the container of FIGS. 10A-10C in accordance with several embodiments;

FIG. 12 is an illustration of a near field and a far field of RFID communication in accordance with some embodiments;

FIGS. 13A-13B are diagrams illustrating the coupling and decoupling of near field and far field components in accordance with some embodiments;

FIG. 14 illustrates a simplified block diagram of an exemplary system illustrating an application using a multi-tag RFID device in accordance with several embodiments;

FIG. 15 is a diagram of a multi-tag RFID device in accordance with several embodiments;

FIG. 16 is a flow diagram of a method in accordance with several embodiments;

FIG. 17 illustrates an exemplary system for use in implementing methods, techniques, devices, apparatuses, systems, servers, sources and detecting retail product label removal from products for sale at a retail facility, in accordance with some embodiments;

FIG. 18A-18B illustrates a simplified block diagram of an exemplary system illustrating an application using a multi-tag RFID device in accordance with several embodiments; and

FIG. 19 illustrates a simplified block diagram of an exemplary system illustrating an application using a multi-tag RFID device in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, a system for use in detecting retail product label removal from products for sale at a retail facility includes a product identifier including a base substrate having a first portion and a second portion. By one approach, the system may include a first radio-frequency identification (RFID) tag device located at the first portion of the base substrate. In one configuration, the first RFID tag device includes a first antenna portion and a first integrated circuit storing a first identifier corresponding to a first retail product. In some implementations, the system may include a second radio-frequency identification (RFID) tag device located at the second portion of the base substrate. By one approach, the second RFID tag device includes a second antenna portion and a second integrated circuit storing a second identifier. Alternatively or in addition to, the system may include a metallic substrate. Alternatively or in addition to, the system may include a first attachment mechanism disposed on a first portion of the metallic substrate. By one approach, the first attachment mechanism may detachably couple the metallic substrate to and cover at least a portion of the second portion of the base substrate including the second integrated circuit. For example, the metallic substrate may cover at least the second integrated circuit and electromagnetically shields the second integrated circuit such that the second RFID tag device is not readable by an RFID tag reader. In one configuration, the metallic substrate does not cover at least a portion of the first portion of the base substrate including the first integrated circuit such that the first RFID tag device is readable by the RFID tag reader.

Alternatively or in addition to, the system may include a second attachment mechanism disposed on a second portion of the metallic substrate. For example, the second attachment mechanism may detachably couple the metallic substrate to at least a portion of the first retail product. In one scenario, the first attachment mechanism may fail with the application of a lower separation force than the second attachment mechanism, such that upon an action causing a separation force to separate the base substrate from the first retail product causing the first attachment mechanism to fail such that the base substrate will be removed from the metallic substrate and the first retail product. For example, upon this separation and removal, the second RFID tag device may then be readable by the RFID tag reader.

In some embodiments, a method for use in detecting retail product label removal from products for sale at a retail facility includes, by a control circuit that is operably coupled to a radio frequency identification (RFID) tag reader, receiving a first signal from the RFID tag reader in response to a first reading of a first RFID tag device located at a first portion of a base substrate of a product identifier. By one approach, the first RFID tag device may include a first antenna portion. Alternatively or in addition to, the first RFID tag device may include a first integrated circuit storing a first identifier corresponding to a first retail product. In one configuration, the product identifier may include a second portion. By one approach, a first attachment mechanism may cover at least a portion of the second portion of the base substrate including a second integrated circuit and may be disposed on a first portion of a metallic substrate. In some implementations, the first attachment mechanism may fail with an application of a lower separation force than a second attachment mechanism disposed on a second portion of the metallic substrate coupled to the first retail product, such that upon an action causing a separation force to separate the base substrate from the first retail product will cause the first attachment mechanism to fail such that the base substrate will be removed from the metallic substrate and the first retail product, and wherein upon this separation and removal, a second RFID tag device will then be readable by the RFID tag reader.

Alternatively or in addition to, the method may include receiving, upon an action causing a separation force to separate the base substrate from the first retail product causing the first attachment mechanism to fail such that the base substrate is removed from the metallic substrate and the first retail product, a second signal from the RFID tag reader in response to a second reading of the second RFID tag device located at the second portion of the base substrate of the product identifier. By one approach, the second RFID tag device may include a second antenna portion and the second integrated circuit storing a second identifier. For example, the metallic substrate may cover at least the second integrated circuit and electromagnetically shields the second integrated circuit such that the second RFID tag device is not readable by the RFID tag reader. In one scenario, the metallic substrate does not cover at least a portion of the first portion of the base substrate including the first integrated circuit such that the first RFID tag device is readable by the RFID tag reader.

In some embodiments, a container is in a closed orientation and upon a given user action, the container can be moved to an at least a partially open orientation. Accordingly, in some embodiments, it is desired to automatically determine an open status of the container. In some embodiments, an RFID-tag reader and RFID tags located at or proximate to the container are used to indicate an open status of the container. In some embodiments, a first RFID tag is fixed to a first portion of the container and a second RFID tag is fixed to a second portion of the container. Upon a user action to at least partially open the container, the first and the second portions will be caused to move relative to each other, resulting in that one or more of the RFID tags will no longer be readable by the RFID-tag reader or will now be readable by the RFID-tag reader. The reading or cessation of reading of one or more RFID tags indicates at least one open status of the container. In some embodiments, the container is closed and in some embodiments, the container is closed and sealed. In some embodiments, the open status is at least one of a fully closed/sealed status, an unsealing confirmation, an open motion initiation status, an open motion confirmation, a partial open status and a fully open status. In some embodiments, the container may take the form of a container locked within a delivered-package vault such as described in U.S. patent application Ser. No. 14/052,102 filed Oct. 11, 2013 and entitled SECURE DELIVERY RECEPTACLE, which is incorporated herein by reference, where the container contains a package for delivery to a recipient, and where it is desired to automatically detect the open status of the container to determine delivery status/completion, for example. In some embodiments, the first portion and the second portion of the container are components that are fixed to the container. In a non-limiting example, the first and second portions components including are a sleeve and an insert coupled to portions of the container.

In some embodiments, one of more of the RFID tags incorporate principles embodied in RFID tags such as those described in U.S. patent application Ser. No. 12/721,527 filed Mar. 10, 2010, now U.S. Pat. No. 8,286,884 issued Oct. 16, 2012 (Docket 98082); U.S. patent application Ser. No. 13/653,324 filed Oct. 16, 2012, now U.S. Pat. No. 8,544,758 issued Oct. 1, 2013 (Docket 103529); U.S. patent application Ser. No. 13/828,821 filed Mar. 14, 2013 (Docket 130347); U.S. patent application Ser. No. 12/884,097 filed Sep. 16, 2010, now U.S. Pat. No. 8,286,887 issued Oct. 16, 2012 (Docket 98183); and U.S. patent application Ser. No. 13/653,331 filed Oct. 16, 2012, now U.S. Pat. No. 8,505,829 issued Aug. 13, 2013 (Docket 130528), all of which are incorporated herein by reference. Such RFID tags are designed such that the near field portion and the far field portion of the RFID tag may be coupled together and decoupled. When coupled, the RFID tag is readable by an RFID tag reader in both the near field of RFID communication and in the far field of RFID communication. When decoupled, the RFID tag is only readable by an RFID tag reader in the near field of RFID communication. In some cases, the near field portion of the RFID tag may be a pre-manufactured generic component which is cooperated with a far field antenna separately designed and manufactured for the application.

In some embodiments, a multi-tag RFID device is provided that includes first and second near field RFID tags implemented on a substrate and that are each coupled to and share a conductive element on the substrate. The conductive element functions as a far field antenna to both the first and second near field only RFID tags. In some embodiments, the RFID device is implemented in a single inlay. Such RFID devices may be used in some embodiments to indicate an open status of a container and/or may be used for other purposes.

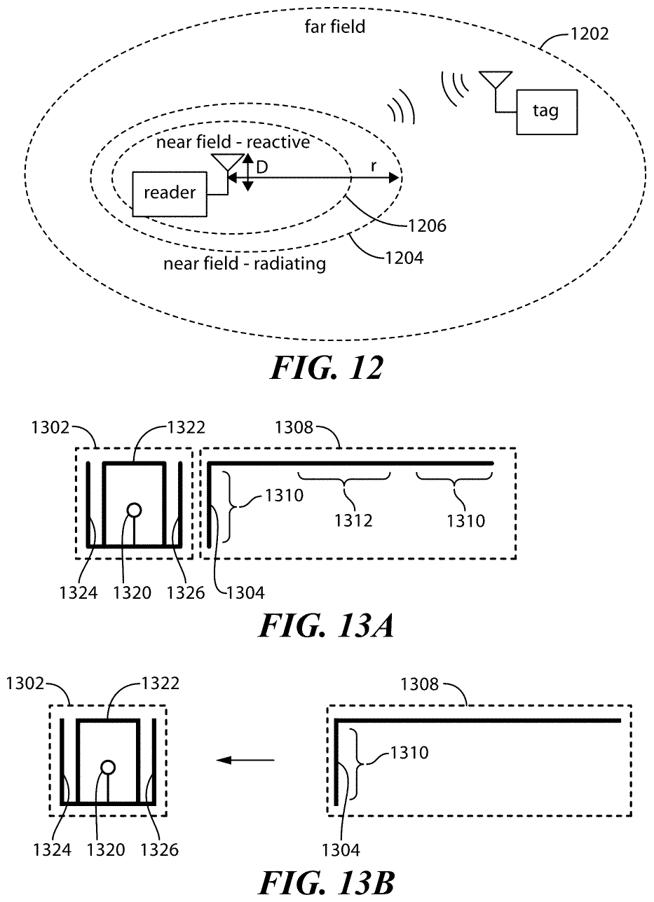

As is well known in the art, referring initially to FIG. 12, embodiments of the near field and the far field of RFID communication are explained and illustrated. For example, the near field is the region about the reader antenna where the reader antenna and the tag are coupled within one full wavelength of the carrier wave; however, in many practical applications, the near field is within one half wavelength of the carrier wave. The far field 1202 is the region beyond the near field region, i.e., coupled beyond one full wavelength of the carrier wave. In the far field, electric and magnetic fields propagate outward as an electromagnetic wave and are perpendicular to each other and the direction of propagation. The angular field distribution does not depend on the distance from the antenna. These electric and magnetic fields are related to each other via free-space impedance. Thus, in the far field region, the electromagnetic signal propagates as waveform.

In the near field region, the electromagnetic signal does not propagate as a waveform. The near field region has two sub-regions: a near field radiating sub-region 1204 and a near field reactive sub-region 1206. In the near field reactive sub-region 1206, energy is stored, but not radiated. The near field reactive sub-region 1206 is typically where the reader antenna and the tag are coupled within ½ wavelength of the carrier wave. This is typically very close to the reader antenna. The near field radiating sub-region 1204 is a transitional region between the near field reactive sub-region 1206 and the far field region 1202. The near field radiating sub-region 1204 is typically where the reader antenna and the tag are coupled between ½ to 1 full wavelength of the carrier wave. In the near field radiating sub-region 1204, while there is radiated electric and magnetic fields, these electric and magnetic fields do not propagate and are not perpendicular to each other and to the direction of propagation (if there were propagation). This is well understood in the art.

In many embodiments, the boundary between the near field region and the far field region can be defined as “r”, illustrated in FIG. 12. In some embodiments, this boundary is a function of the antenna characteristics (e.g., the antenna's electrical size) and the wavelengths used, as well as whether the reader is a point source or array. In some embodiments, with antennas whose size is comparable to wavelength (such as commonly used in UHF RFID applications), the approximate boundary (r) between the far field and the near field regions may be expressed as r=2D²/λ. where D is the maximum antenna dimension and λ, is the wavelength. For electrically small antennas (e.g., as used in LF/HF RFID applications), the near field radiating sub-region is small and the boundary r between near and far fields may be expressed as r=λ/2π. These relationships are well known in the art.

Generally, the near field and far fields of RFID communication are well known in the art. Many near field devices include devices complying with the Near Field Communication (NFC) Forum standards, High Frequency (HF) devices, Electronic Shelf Labels (ESLs), and so on. Other examples of devices that communicate in the near field are near field only tags such as those tags described in U.S. Pat. Nos. 8,286,884 and 8,286,887, both of which are incorporated herein by reference, i.e., tags that lack a far field antenna and magnetically, inductively or capacitively couple to a corresponding reader. Devices that communicate in the near field typically have a range of being detected at about an inch or so away up to about 1-2 feet maximum depending on the frequencies used.

In a typical ultra-high frequency (UHF) RFID system where the carrier frequency is in the range of 860-960 MHz, the effective near field is the region up to approximately 1-15 centimeters from the reader antenna, whereas the far field is the region from approximately 15-40 centimeters and beyond the reader antenna. In many cases, the reader can read tags in the near field up to about 15 centimeters away, whereas depending on the tag antenna, the reader can read tags in the far field up to about 20-30 feet or more away. These features are also well known in the art.

It is understood that the near field tags may be designed to operate with reader antennas operating at a variety of frequencies, such as low frequency (LF) at 125-134 kHz, high frequency (HF) at 13.56 MHz, ultra high frequency (UHF) at 860-960 MHz, microwave frequencies at 2.4 and 5.8 GHz, for example.

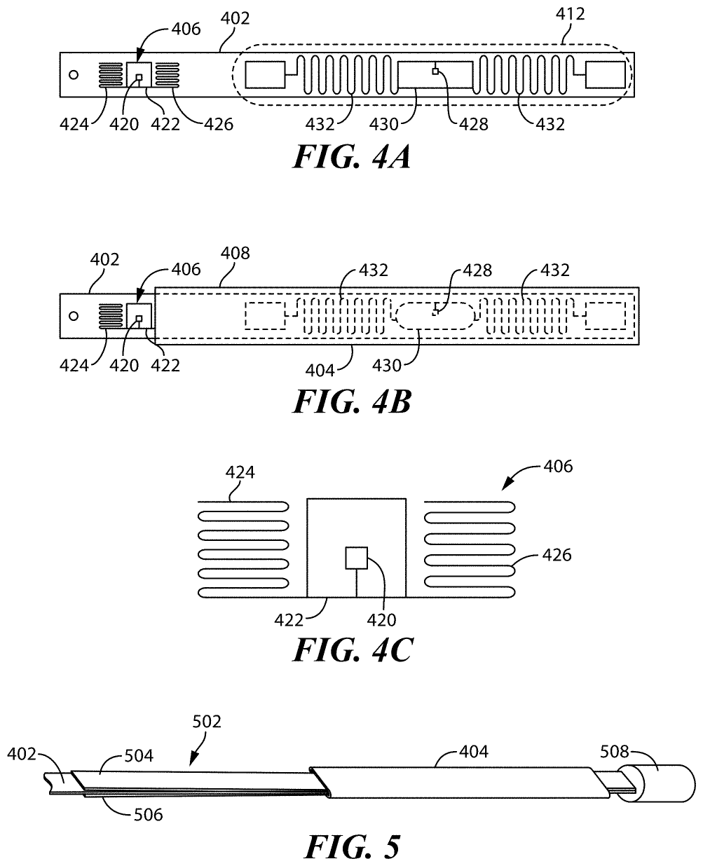

Another way to view near field and far field communications relates to how the reader and the tag are coupled together. The reader and a near field tag communicate through magnetic, inductive or capacitive coupling between the reader antenna and the tag antenna (typically a near field loop antenna). For example, a current is induced in the reader antenna (e.g., loop antenna), which when brought into close range with the tag antenna (loop antenna) induces a current in the tag antenna which is modulated according to the data of the tag and induced back to the reader antenna. This type of near field communication is well known in the art and may be considered the near field reactive sub-region 1206 of FIG. 12. Devices capable of communicating in the near field radiating sub-region need more than a loop antenna. For example, at least some additional conducting portion extending from the loop antenna (such as the conductors 424 and 426 of FIG. 4C discussed below). Such conductors will provide some radiation of the electric and magnetic fields but not provide a propagation of a waveform. This type of near field communication is well known in the art and may be considered the near field radiating sub-region 1204 of FIG. 12.

With far field RFID devices, the reader and the tag communicate through the transmission of electromagnetic energy from the reader to the tag which is reflected back as transmitted electromagnetic energy to the reader. Far field communicating devices typically use dipole antennas or other antenna structures capable of transmitting energy and received transmitted energy in the far field. In many cases, the far field radiation decays as described in the far field region 1202 of FIG. 12. This type of far field communication is well known in the art. Further information regarding the near field and far fields of RFID operation are described in NIKITIN ET AL., “An Overview of Near Field UHF RFID”, IEEE, February 2007, which is incorporated herein by reference.

It is noted that in some embodiments, the read range of a given reader may be limited or changed by reducing or adjusting the power level of signals transmitted by the RFID reader. For example, far field RFID readers at normal operating power levels may be able to read far field RFID tags up to 20-30 feet. For example, the transmit power of the reader could be adjusted such that the reader can only read RFID tags at less than the normal range, e.g., up to 10-20 feet. This allows for the reading of the tag to occur only when the tag and tag reader are brought into a closer proximity compared to when the reader reads at normal power levels. Conversely, the increase of the read range results in the detection of a less precise (farther) location relationship between the reader and the tag than when the RFID reader operates at normal power.

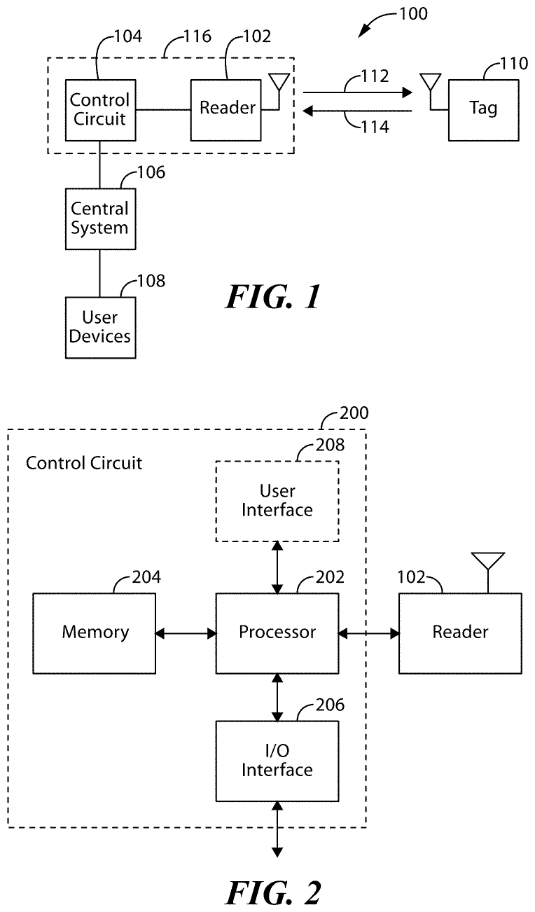

Referring now to FIG. 1, a system 100 is shown including an RFID reader 102 (which may also be referred to as an RFID-tag reader or simply as a reader) which is coupled to a control circuit 104 which is coupled to a central system 106 and which is in turn coupled to one or more user devices 108. As is well known in the art, the RFID reader 102 is configured to “read” any RFID tags (which may also be referred to as RFID transceivers), such as RFID tag 110 within the operating range of both the RFID reader 102 and the RFID tag 110. For example, as illustrated in FIG. 1, in a passive RFID communication system, the RFID reader 102 includes a reader antenna and transmits a modulated radio frequency (RF) signal 112 to the RFID tag 110 (and any other RFID tag within range). The tag antenna receives the RF signal and forms an electric and magnetic field from which the RFID tag 110 draws power for the integrated circuit of the RFID tag 110. The integrated circuit then causes the RFID tag 110 to modulate a backscatter RF signal 114 back to the RFID tag reader 102, the RF signal 114 containing information encoded in the memory of the RFID tag 110, such as the ID of the RFID tag 110. The functionality and operation of the reading of tags by the RFID reader 102 and the RFID tag 110 is well known in the art.

In several embodiments, the RFID tag 110 is located on or proximate to a container which is normally in a closed orientation and is designed to be moved into an open orientation by a user. The RFID reader 102 is used to read the RFID tag 110. Information or signaling indicating whether the RFID tag 110 is read or not by the RFID reader 102 is passed to the control circuit 104 and in some embodiments, used to determine an open status of the container. In some embodiments, the RFID tag reader 102 is located in the far field of RFID communication relative to the location of the RFID tag 110. As such, in embodiments where the RFID tag 110 comprises decoupleable near field and far field components, the RFID tag 110 is readable by the RFID reader when the near field and far field components are coupled together. The RFID tag 110 is no longer readable by the RFID reader when the near field and far field components are decoupled, since the RFID tag would only be readable in the near field and the RFID reader is in the far field of RFID communication relative to the RFID tag.

In some embodiments, the control circuit 104 is integrated with or part of the device or apparatus including the RFID reader 102 (as indicated by the dashed box 116). In some embodiments, the control circuit 104 and the RFID reader 102 are integrated on the same integrated circuit device, e.g., on the same circuit board. In such cases, it is noted that when the RFID reader 102 and control circuit 104 are integrated, a function indicated herein as being performed by the control circuit may also be performed by the RFID reader 102. In other embodiments, the control circuit 104 is separate from and coupled to the RFID reader 102. For example, the control circuit 104 may be located at, integrated into or coupled to the central system 106. In such cases, the control circuit 104 is coupled by one or more wired and/or wireless communication links using the appropriate communicating devices. In some embodiments, the central system 106 may be at a physical location or local to the location of the control circuit 104 and/or reader 102, or may be at a remote location, for example, the central system 106 is a remote system (in the cloud) and coupled to the control circuit 104 via a network. Further, in some embodiments, the central system 106 may be used to store and monitor the open status of containers that are initially in a closed orientation, but are intended to be opened by a user, where such detection and determinations of open status are made by the control circuit 104. Such information and/or open statuses may be communicated for stored, display, communication, etc. to various user devices 108.

FIG. 2 illustrates one embodiment of a control circuit such as generally shown in FIG. 1. The control circuit 200 includes a processor 202, a memory 204, an input/output (I/O) interface 206 and an optional user interface 208. Generally, the memory 204 stores the operational code or set of instructions that is executed by the processor 202 to implement the functionality of the circuit. The memory 204 also stores any particular data that may be needed to detect the open status and make the determinations discussed herein. Such data may be pre-stored in the memory or be received, for example, from the central system 106 during use. It is understood that the processor 202 may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the system 200; however, the memory 204 can be internal, external or a combination of internal and external memory. Additionally, the control circuit may include a power supply (not shown) or it may receive power from an external source.

The processor 202 and the memory 204 may be integrated together, such as in a microcontroller, application specification integrated circuit, field programmable gate array or other such device, or may be separate devices coupled together. The I/O interface 206 allows communicational coupling of the control circuit to external components, such as the central system 106 and/or user devices 108. Accordingly, the I/O interface 206 may include any known wired and/or wireless interfacing device, circuit and/or connecting device. In some embodiments, a user interface 208 is included in the control circuit 200 which may be used for user input and/or output display. For example, the user interface 208 may include any known input devices, such a buttons, knobs, selectors, switches, keys, touch input surfaces and/or displays, etc. Additionally, the user interface 208 may include one or more output display devices, such as lights, visual indicators, display screens, etc. to convey information to a user, such as a given open status of a given container. The control circuit 200 is configured to communicate with the reader 102 to control its operation and to receive information from the RFID reader 102 regarding the reading of certain RFID tags. While FIG. 2 illustrates the RFID reader 102 being coupled to the processor 202, it is understood that the reader 102 may actually be coupled to a communication bus of the control circuit 200 to which the processor 202 and/or memory 204 may also be coupled. In some embodiments, the control circuit 200 and the RFID reader 102 are integrated on the same integrated circuit device, e.g., on the same circuit board.

Generally, the control circuits 104 and 200 can comprise a fixed-purpose hard-wired platform or can comprise a partially or wholly programmable platform. These architectural options are well known and understood in the art and require no further description here. These control circuits 104 and 200 are configured (for example, by using corresponding programming as will be well understood by those skilled in the art) to carry out one or more of the steps, actions, and/or functions described herein.

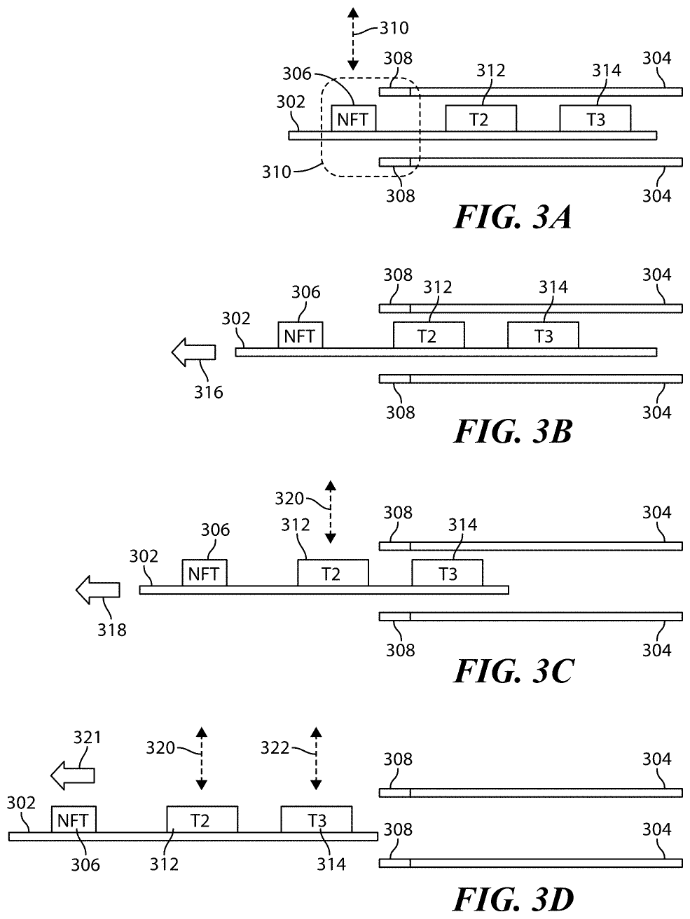

Referring next to FIGS. 3A-3D, diagrams are shown illustrating an application in accordance with several embodiments in order to automatically detect an open status of a container normally in a closed orientation and for which will be moved to at least a partially open orientation by user action. A first portion 302 of the container and a second portion 304 of the container are removably coupled to each other. In the illustrated embodiment, the first portion 302 comprises an insert that at least partially fits within a space formed by the second portion 304, which is embodied as a sleeve. In some embodiments, one or both of the first portion 302 and the second portion 304 are integral to or part of the container. In some embodiments, one or both of the first portion 302 and the second portion 304 are components that are fixed to container.

In some embodiments, the first portion 302 includes one or more RFID tag devices. In the illustrated embodiments, a first RFID tag 306 is coupled (e.g., applied, formed, integrated, adhered, etc.) to a surface of the first portion 306, where the first RFID tag 306 is configured by itself to communicate only in a near field of RFID communication. For example, the first RFID tag 306 includes a chip and a near field antenna (e.g., loop antenna). In some embodiments, the first RFID tag may be referred to as a near field only RFID tag. A conductive element 308 is implemented (e.g., formed, printed, patterned, etched, adhered, etc.) at the second portion 304. The conductive element 308 is located in proximity to the first RFID tag 306 when the container is in the closed orientation. The conductive element 308 is configured to function as a far field antenna for the first RFID tag 306 such that the first RFID tag 306 is readable by an RFID reader in a far field of RFID communication when the container is in the closed orientation (illustrated in FIG. 3A). It is noted that the first RFID tag 306 is also readable in the near field of RFID communication. FIG. 3A illustrates the readability of the first RFID tag in the far field as dashed arrow 310. Further details and implementations of near field only RFID tag devices coupled together with conductive elements forming far field antennas as described in the patents and patent applications incorporated herein by reference above.

As illustrated, the first RFID tag 306 extends from the space formed by the second portion, e.g., it is not covered by the second portion 304. In some embodiments, the conductive element 308 is formed at or near a periphery edge of the second portion 304 such that the conductive element 308 inductively, electrically or capacitively couples to the near field antenna (e.g., loop antenna) of the first RFID tag 306. In some embodiments, if the conductive element 308 were to cover the first RFID tag 306, it would electromagnetically shield the first RFID tag such that the first RFID tag 306 would not be readable in the far field of RFID communication.

A second RFID tag 312 is fixed to the first portion 302 such that the second RFID tag 312 is shielded by the second portion 304 and is not readable by the RFID reader when the container is in the closed orientation. For example, in some embodiments, the second portion 304 is made of a conductive material that substantially surrounds the second RFID tag 312 and functions as a Faraday cage making it unreadable in the far field of RFID communication. In some embodiments, an optional third RFID tag 314 is fixed to the first portion 302 such that the third RFID tag 314 is also shielded by the second portion 304 and is not readable by the RFID reader when the container is in the closed orientation. For example, in some embodiments, the second portion 304 substantially surrounds the third RFID tag 314 functioning as a Faraday cage and making it unreadable in the far field of RFID communication.

Thus, in some embodiments, as illustrated in FIG. 3A, when the container is in the closed orientation, the first RFID tag 306 is readable by the RFID reader in the far field of RFID communication, whereas the second RFID tag 312 and the third RFID tag 314 are not readable in the far field.

FIG. 3B illustrates the relative positioning of the first portion 302 and the second portion 304 upon a user action to open the container at least a first amount. The relative motion is illustrated for example as the first portion 302 moving in the direction of arrow 316. Such movement decouples the first RFID tag 306 (e.g., near field only device) from the conductive element 308 (e.g. far field antenna) such that the first RFID tag 306 is no longer readable in the far field. In some embodiments, the cessation of readability of the first RFID tag 306 indicates a first open status of the container. Depending on the embodiment, the first open status may correspond to one or both of an unsealed status and an open motion initiation status of the container. In FIG. 3B, the second RFID tag 312 and the third RFID tag 314 are still shielded by the second portion 304 and; thus, as not readable by the RFID reader in the far field.

FIG. 3C illustrates the relative positioning of the first portion 302 and the second portion 304 upon a user action to further open the container at least a second amount. The relative motion is illustrated for example as the first portion 302 moving in the direction of arrow 318. Such movement further results in the exposure or unshielding of the second RFID tag 312 which is now readable by an RFID reader in the far field, as indicated by dashed arrow 320. In this orientation, the first RFID tag 306 and the third RFID tag 314 are not readable in the far field, but the second RFID tag 312 is. In some embodiments, the reading of the second RFID tag 312 indicates a second open status of the container. Depending on the embodiment, the second open status may correspond to or comprise at least one of an unsealing confirmation, an open motion initiation status, an open motion confirmation, a partial open status and a fully open status of the container.

FIG. 3D illustrates the relative positioning of the first portion 302 and the second portion 304 upon a user action to further open the container at least a third amount. The relative motion is illustrated for example as the first portion 302 moving in the direction of arrow 321. Such movement further results in the exposure or unshielding of the third RFID tag 314 which is now readable by an RFID reader in the far field, as indicated by dashed arrow 322. In this orientation, the first RFID tag 306 is not readable in the far field, but the second RFID tag 312 and the third RFID tag 314 are. In some embodiments, the reading of the third RFID tag 314 indicates a third open status of the container. Depending on the embodiment, the third open status may correspond to or comprise at least one of a partial open status and a fully open status of the container.

FIGS. 3A-3D illustrate various opening motions triggered by the user. In some embodiments, each motion is a separate incremental motion. In some embodiments, each motion is a portion or positional snapshot of one continuous motion.

In some embodiments, the reading and cessation of reading of one or more RFID tags provides indications of an open status of the container. For example, in one embodiment, when the first RFID tag 306 is read in the far field by the RFID reader (e.g., see FIG. 3A), the open status of the container corresponds to fully closed and optionally fully sealed depending on the closure mechanism of the container. When the first portion and the second portion are moved relative to each other at least a first amount (e.g., see FIG. 3B), the first RFID tag 306 is no longer readable in the far field. In some embodiments, this indicates an unsealed status or an open motion initiation status. When the first portion and the second portion are moved relative to each other at least a second amount (e.g., see FIG. 3C), the second RFID tag 312 is now readable in the far field indicating that the open status is one or more of an unsealing confirmation, an open motion initiation status, an open motion confirmation, a partial open status and a fully open status. In some embodiments, an unsealing confirmation status is an indication that confirms that the container has been unsealed, an open motion initiation status is an indication that the opening motion has begun, and an open motion confirmation status is an indication that the opening motion has been initiated or confirmed. In some embodiments, a partial open status and a fully open status are indications that the container is partially open and fully open, respectively. Whether the indication is partial or fully open is a function of the range of motion of the first portion 302 and the second portion 304, the range of motion needed for the container to be partially or fully open, and/or the location of the second RFID tag on the first portion.

In embodiments with the third RFID tag 314, when the first portion and the second portion are moved relative to each other at least a third amount (e.g., see FIG. 3D), the third RFID tag 314 is now readable in the far field indicating that the open status is a fully open status. For example, in such embodiments, typically the reading of the second RFID tag 312 would indicate one or more of an unsealing confirmation, an open motion confirmation, and a partial open status, and the reading of the third RFID tag 314 would indicate an open status being fully open.

It is understood that while FIGS. 3A-3D illustrate the first portion moving relative to a stationary second portion, the relative movement may occur in any way that results in this relative movement. For example, the second portion could be moved relative to a fixed first portion. In another example, both of the first portion and the second portion could be moved relative to each other in the user's opening motion.

In order to distinguish between tag reads, each tag can be encoded with a unique identifier known to the control circuit and that is provided by the reader when being read. In some embodiments, the tags may be encoded with an Electronic Product Code (EPC) such as a Serialised Global Trade Item Number (SGTIN) of the EPCGlobal Tag Data Standard as is well known in the art. In some embodiments, the unique identifiers are identical to each except for at least one bit, e.g., the last 1-2 bits of a SGTIN EPC code could be different. By using embodiments that allow automatic detection of the open status of a container, it can be determined automatically and without visual inspection if a given container has been opened, or has been unsealed but not fully opened.

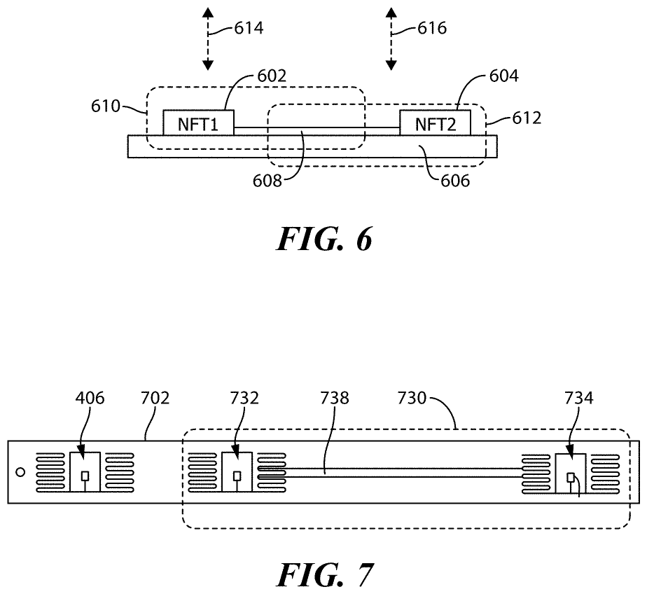

While the first RFID tag 306 is illustrated as a decoupled design RFID tag such as described in the patent and applications incorporated herein by reference, the second and third RFID tags could be any RFID tag design known in the art that is readable in the far field of RFID communication. Further, in some embodiments, the second and third tags could be implemented as a multi-tag RFID device that includes first and second near field RFID tags implemented on a substrate and that are each coupled to and share a conductive element on the substrate that functions as a far field antenna to both the first and second near field only RFID tags, such as described with reference to FIGS. 6 and 7.

Referring to the plan views of FIGS. 4A and 4B, an exemplary first component 402 and second component 404 (i.e., more specific examples of the first portion 302 and the second portion 304 of FIGS. 3A-3D) of a container is shown. In FIG. 4A, the first component 402 includes a first RFID tag 406 and a second RFID tag 412 fixed thereto. In this embodiment, the first component 402 is embodied as an insert that fits within a space formed by the second component 404 (seen in FIG. 4B).

The first RFID tag 406 is configured to operate only in the near field of RFID communications. Accordingly, the first RFID tag 406 includes an integrated circuit or chip and near field antenna (e.g., loop antenna). For example, as is illustrated in more detail in FIG. 4C, the first RFID tag 406 includes an integrated circuit or chip 420 coupled to a near field antenna 422 (e.g., loop antenna) and including elongated conductors 424 and 426 that allow the loop antenna 422 to be coupled to a far field antenna. In some embodiments, the near field RFID tag 406 may be implemented as the Impinj® Bolt™ (commercially available from Impinj, Inc. of Seattle, Wash.) which is a near field only tag that has a chip with a loop antenna and patterned elongated conductors to allow for capacitive coupling of the loop to a far field antenna. It is noted that the loop antenna 422 allows for communication in the near field reactive sub-region 1206, and the conductors 424 and 426 allow for communication in the near field radiating sub-region 1204. In some embodiments, the near field RFID tag 406 may be implemented as the Impinj® Button™ (commercially available from Impinj, Inc. of Seattle, Wash.) which is a near field only tag that has a chip with a circular loop antenna (and no patterned elongated conductors), which on its own only allows for communication in the near field reactive sub-region 1206.

The second component 404 includes a portion thereof that implements a conductive element 408 that functions as a far field antenna. When the first component 402 is received within the second component 404 (see FIG. 4B), the conductive element 408 is coupled (e.g., electrically, inductively or capacitively) to the near field antenna 422 of the first RFID tag 406 (e.g., the conductive element 408 capacitively couples to the conductor 426 and loop antenna 422) such that the first RFID tag 406 is readable in the far field of RFID communications. When the first component 402 is moved relative to the second component 404 (e.g., pulled out to the left in the illustration), the first RFID tag 406 is decoupled from the conductive element 408 such that the first RFID tag 406 is no longer readable in the far field.

The second RFID tag 412 can be any RFID tag device that is capable of being read in far field. For example, as shown in FIGS. 4A and 4B, the second RFID tag 412 takes the form of a standard inlay having an integrated circuit or chip 428 and near field antenna 430 (e.g., loop antenna) electrically coupled to and integrated with a far field antenna structure 432. In the illustrated embodiment, the far field antenna structure 432 is a dipole antenna structure and is part of the same inlay device. When the first component 402 is received within the second component 404 (see FIG. 4B), the second RFID tag 412 is shielded by the second component 404 such that it cannot be read by the RFID reader. When the first component 402 is moved relative to the second component 404 to expose the second RFID tag 412, the second RFID tag 412 is no longer shielded and may be read by the RFID reader in the far field.

Relative to the generic embodiments of FIGS. 3A-3D, the first RFID tag 406 is an embodiment of the first RFID tag 306, and the second RFID tag 412 is an embodiment of the second RFID tag 312. In the embodiment of FIGS. 4A-4B, there is no embodiment of a third RFID tag, but it is understood that a third RFID tag could be added.

In some embodiments, the first component is an insert configured to fit within the second component which may be embodied as a sleeve. In some embodiments, the insert is at least partially flexible such that it can be removed from the sleeve but not easily re-inserted back into the sleeve. In some embodiments, a tool is provided to insert the first component within the sleeve. For example, an insert tool 502 is shown in FIG. 5. In some embodiments, the tool 502 comprises a handle 508 and two elongated pieces 504 and 506 (e.g., blades or plates) that sandwich the first component 402. The tool 502 is generally more rigid that the first component 402. In some embodiments, the tool is inserted through the second component 404 from a through side, while the first component 402 is sandwiched between the pieces 504 and 506 extending from the second component. Then the tool 502 is pulled by the handle 508 to guide the first component 402 into the second component 404. Once the first component 402 is fully inserted, the tool 502 is pulled free of the second component 404.

Referring next to FIG. 6, a side elevation view is shown of a multi-tag RFID device 600 including a first near field RFID tag device 602 and a second near field RFID tag device 604 implemented on a substrate 606 and that are each coupled to and share a conductive element 608 on the substrate that functions as a far field antenna to both the first and second near field RFID tag devices 602 and 604. In the illustrated embodiments, the first near field RFID tag device 602 is fixed at a first portion (e.g., first end) of the substrate and the second near field RFID tag device 604 is fixed at a second portion (e.g., second end) of the substrate. In some embodiments, the first and second near field RFID tag devices are fixed to the substrate being spaced apart from each other.

Generally, each of the near field RFID tag devices includes an integrated circuit device or chip and a near field antenna (e.g., a loop antenna), and optionally any coupling structure that may be needed or desired to couple the near field antenna to the conductive element. The conductive element 608 may be any far field antenna structure or pattern as is known in the arts. The conductive element 608 can be configured to couple to the antenna of each of the near field RFID tag devices through one of electrical, inductive and capacitive coupling. Such various coupling approaches are further described in the patents and patent applications incorporated herein by reference. In some embodiments, the near field RFID tag devices and the conductive element are manufactured together and implemented on a single inlay device.

Functionally, the first near field RFID tag device 602 couples with the conductive element 608 to form a first combination near field and far field RFID tag 610 that can be read in the near field as well as in the far field. Arrow 614 indicates the readability of the RFID tag 610 in the far field of RFID communication. The second near field RFID tag device 604 couples with the conductive element 608 to form a second combination near field and far field RFID tag 612 that can be read in the near field as well as in the far field. Arrow 616 indicates the readability of the RFID tag 512 in the far field of RFID communication.

It is understood that while two near field RFID tag devices are illustrated, three or more near field RFID tag devices could be implemented on the substrate and spaced apart from the other near field RFID tag devices and also share the conductive element.

In some embodiments, the multi-tag RFID device may be useful in applications where one or more of the near field RFID tag devices can be selectively shielded, e.g., by a conductive barrier positioned about the one or more near field RFID tag devices. Such can result in the selective readability of one or more of the near field RFID tag devices to an RFID reader, which can be used to make automated determinations and/or detections.

In some embodiments, a multi-tag RFID device may be implemented on the first portion (e.g., first component) of a container and useful to indicate one or more open statuses of the container. Referring to FIG. 7, an embodiment of the first component of FIGS. 4A and 4B is shown where a multi-tag RFID device 730 is used to implement second and third RFID tags (e.g., second and third RFID tags 312 and 314). For example, the first component 702 includes the first RFID tag 406 and a multi-tag RFID device 730 including a first near field RFID tag device 732 and a second near field RFID tag device 734 that are each coupled to and share a conductive element 738 that functions as a far field antenna to both the first and second near field RFID tag devices 732 and 734. The first near field RFID tag device 732 and the conductive element 738 couple together and function as a second RFID tag (e.g., second RFID tag 312 or 412). The second near field RFID tag device 734 and the conductive element 738 couple together and function as a third RFID tag (e.g., third RFID tag 314). In some embodiments, each of the first and second near field RFID tag devices 732 and 734 include an integrated circuit or chip (e.g., chip 428, 420) and a near field antenna (e.g., loop antenna 422, 430).

When the first component 702 is fully inserted into the second component 404, the first RFID tag 406 couples to the conductive element 408 such that the first RFID tag 406 is readable in the far field. When the first component 402 is moved relative to the second component 404 a first amount (such as in FIG. 3B), the first RFID tag 406 is no longer readable in the far field, and both the first near field RFID tag device 732 and the second near field RFID tag device 734 are likewise not readable in the far field since they are shielded by the second component 404. When the first component 402 is moved relative to the second component 404 a second amount (such as in FIG. 3C), the first near field RFID tag device 732 is exposed making it readable in the far field whereas the second near field RFID tag device 734 is not readable in the far field since it is still shielded by the second component 404. When the first component 402 is moved relative to the second component 404 a third amount (such as in FIG. 3C), both the first near field RFID tag device 732 and the second near field RFID tag device 734 are exposed, making them both readable in the far field.

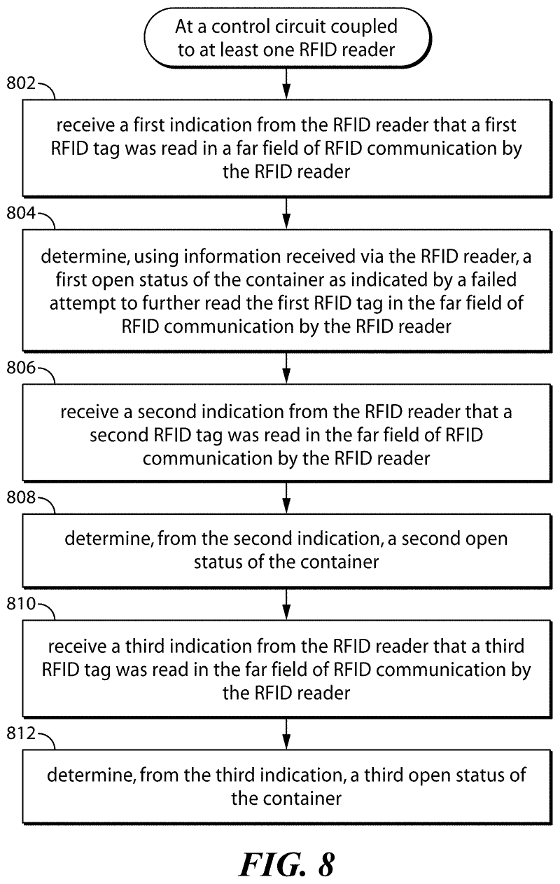

Reference is now made to the flow diagram of FIG. 8 which illustrates a process occurring at a control circuit (e.g., control circuits 104 and/or 200) coupled to at least one RFID reader in accordance with several embodiments. The process of FIG. 8 may be performed by one or more of the systems and applications described herein.

Generally, the control circuit uses (or is configured to use) at least information received via the RFID reader regarding a reading of one or more RFID tags by the RFID reader, to determine one or more open statuses of a container normally in a closed orientation and which can at least be partially opened.

In Step 802, the control circuit receives a first indication from the RFID reader that a first RFID tag was read in a far field of RFID communication by the RFID reader. In some embodiments, the first RFID tag is fixed to a first portion of the container and configured by itself to communicate only in a near field of RFID operation. The first RFID tag is located in proximity to a conductive element implemented at a second portion of the container when the container is in the closed orientation, such that the conductive element is configured to function as a far field antenna for the first RFID tag when the container is in the closed orientation. In this arrangement and configuration, the first RFID tag is readable and is read in the far field of RFID communication (e.g. see the first RFID tag 306 in FIG. 3A). In some embodiments, the reading of the first RFID tag indicates the open status of the container as being fully closed or fully sealed.

Upon a user action to open the container at least a first amount (e.g., see FIG. 3B), the first portion and the second portion of the container move relative to each other decoupling the conductive element from the first RFID tag such that the first RFID tag is no longer readable in the far field. In this case, the first RFID tag can no longer be read in the far field and attempts to read the first RFID tag will result in a failure. In step 804, the control circuit determines, using information received via the RFID reader, a first open status of the container as indicated by a failed attempt to further read the first RFID tag in the far field of RFID communication by the RFID reader. In some embodiments, the first open status comprises at least one of an unsealed status and an opening motion initiation status.

The container also includes a second RFID tag that is fixed to the first portion of the container such that the second RFID tag is shielded by the second portion and is not readable by the RFID reader when the container is in the closed orientation. Next, upon a user action to open the container at least a second amount (e.g., see FIG. 3C), the first portion and the second portion move relative to each other such that the second RFID tag is no longer shielded and is now readable in the far field by the RFID reader. In this case, the second RFID tag will respond to interrogation signaling from the RFID reader, e.g., providing its identification. The RFID reader will now be able to read the second RFID tag in the far field. In step 806, the control circuit receives a second indication from the RFID reader that a second RFID tag was read in the far field of RFID communication by the RFID reader. In step 808, the control circuit determines, from the second indication, a second open status of the container. Depending on the embodiment, the second open status comprises one or more of an unsealing confirmation, an open motion initiation status, an open motion confirmation, a partial open status and a fully open status.

The container also includes a third RFID tag that is fixed to the first portion such that the third RFID tag is shielded by the second portion and is not readable by the RFID reader when the container is in the closed orientation. Upon a user action to open the container at least a third amount (e.g., see FIG. 3D), the first portion and the second portion move relative to each other such that the third RFID tag is no longer shielded and is now readable by the RFID reader. In this case, the third RFID tag will respond to interrogation signaling from the RFID reader, e.g., providing its identification. The RFID reader will now be able to read the third RFID tag in the far field. In step 810, the control circuit receives a third indication from the RFID reader that a third RFID tag was read in the far field of RFID communication by the RFID reader. In step 812, the control circuit determines, from the third indication, a third open status of the container. In some embodiments, the third open status comprises a fully open status.

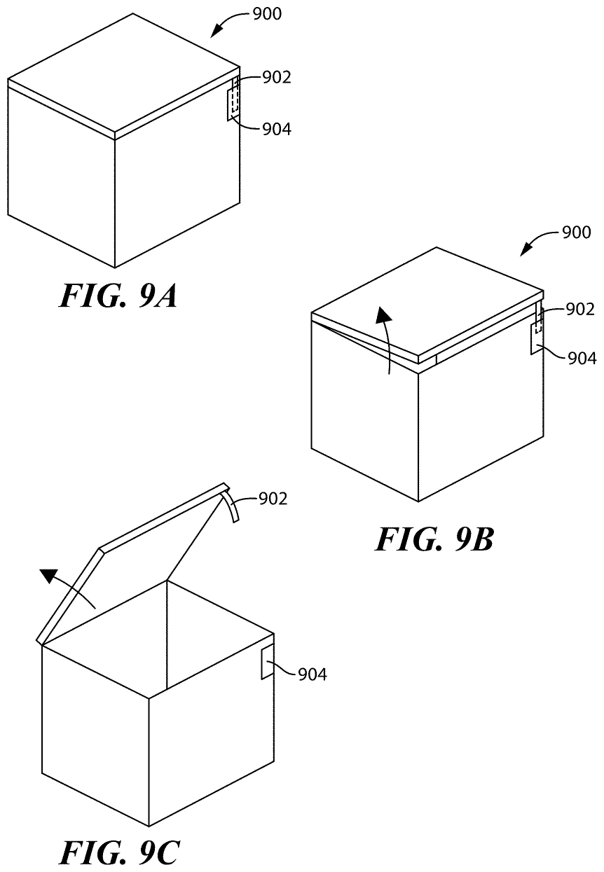

Referring next to FIGS. 9A-9C, illustrations are shown of a generic container 900 normally in a closed orientation (see FIG. 9A) and which will be at least partially opened through user actions (see FIGS. 9B and 9C). In these embodiments, the container 900 includes a first portion 902 and a second portion 904 that are removably coupled to each other. For example, in the illustrated embodiment, the first portion 902 is a first component (e.g., the first component 302, 402 or 702) coupled to a lid of the container and the second portion 904 is a second component (e.g., the second component 302 or 402) coupled to a body of the container. In FIG. 9A, a first RFID tag (e.g., first RFID tag 306) is readable in the far field since it is coupled a conductive element (e.g., element 308) of the second portion, but the second and optional third RFID tags (e.g., RFID tags 312 and 314) are shielded by the second portion and are not readable in the far field. In some embodiments, given that only the first RFID tag is readable in the far field, this indicates that the open status of the container is fully closed and/or fully sealed.

In FIG. 9B, the first and second portions 902 and 904 have been moved an amount relative to each other, which decouples the first RFID tag from the conductive element such that the first RFID tag is not readable in the far field. Depending on how far the first and second portions 902 and 904 are moved relative to each other, the second RFID tag (e.g., RFID tag 312) may or may not be readable in the far field. That is, the amount of movement will indicate whether the example diagram of FIG. 3B or 3C is applicable. In FIG. 9B, the optional third RFID tag is shielded by the second portion 904. In some embodiments, if the first RFID tag is no longer readable in the far field, this indicates an open status of one or more of an unsealed status and an opening motion initiation status. In some embodiments, if the second RFID tag is also readable, this can indicate an open status of one or more of an unsealing confirmation, an open motion confirmation, a partial open status and a fully open status. In the illustrated embodiment, the open status is all of an unsealing confirmation, an open motion confirmation, and a partial open status.

In FIG. 9C, the first and second portions 902 and 904 have been moved a further amount relative to each other such that one or both of the second and third RFID tags are now readable in the far field, e.g., such as in the illustration of FIG. 3D. In some embodiments, if the second RFID tag and optional third RFID tag are also readable, this indicates an open status of one or more of an unsealing confirmation, an open motion confirmation, a partial open status and a fully open status. In the illustrated form, the open status is fully open.

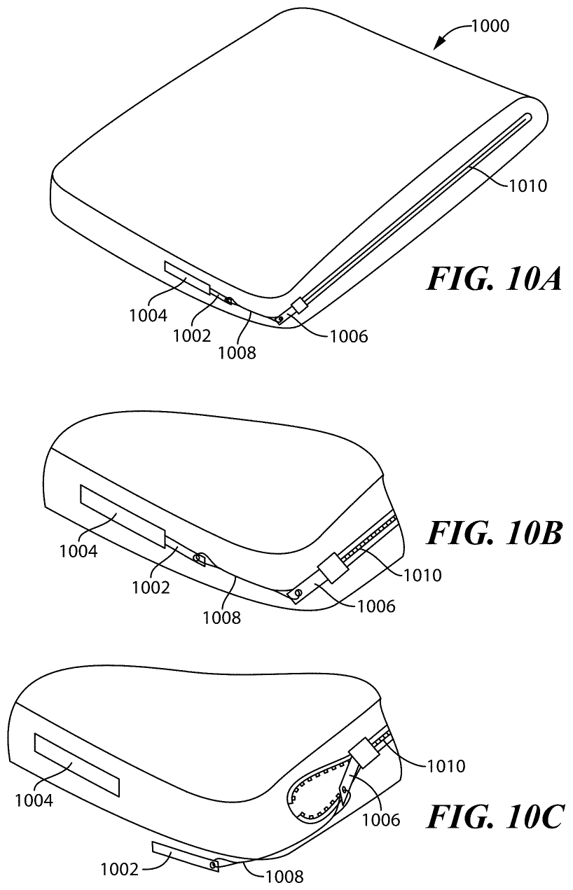

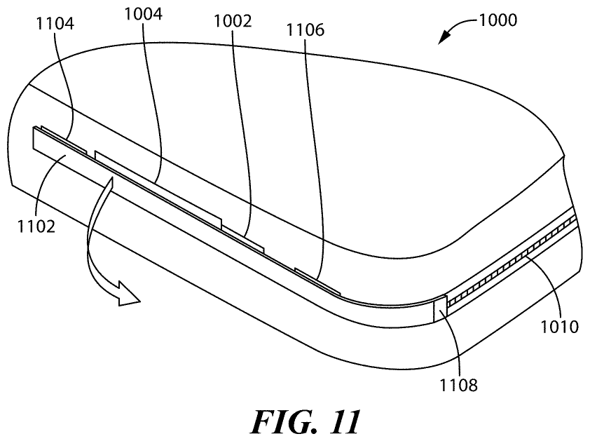

While the container illustrated in FIGS. 9A-9C takes the form of a box-like container, it is understood that the containers described herein may be implemented any type of known container or any shape, size, material weight, enclosure mechanism known the art. In this regard, FIGS. 10A-10C illustrate another container 1000 taking the form of a zippered bag or pouch. FIG. 10A and the enlargement of FIG. 10B illustrate the container 1000 in the closed orientation where a first portion 1002 is inserted within a second portion 1004 coupled to an exterior portion of the container 1000. The first portion 1002 is coupled by a connector 1008 (string or wire) to a zipper pull 1006 of a zipper 1010. As illustrated in FIG. 10C, when the user pulls the zipper pull 1006 to open the container 1000, the first portion 1002 is removed at least some amount from the second portion 1004. In FIG. 10C, the first portion 1002 is fully removed from the second portion 1004. The degree of removal of the first portion 1002 from the second portion 1004 and the cessation of reading and the readability of certain RFID tags will indicate various open statuses of the container, which are automatically determined by a control circuit coupled to an RFID reader. The first and second portions 1002 and 1004 can be in accordance with any such portions or components described and taught herein.

In a variation of FIGS. 10A-10C, as shown in FIG. 11, a protective flap 1102 is positioned over the first portion 1002 and the second portion 1004 and is connected to the zipper 1010. The under surface of the protective flap 1102 includes a top Velcro surface (one of hook and loop structured surfaces) mated to bottom Velcro surfaces 1104 and 1106 (the other of hook and loop structured surfaces) in order to hold the flap 1102 in position over the first and second portions. To open the container, the flap 1102 is peeled back and pulled. In this embodiment, the flap is coupled to the first portion 1002 and to the zipper 1010 at the pull location 1108; thus, the flap becomes the zipper pull. When the flap 1102 is pulled back (even before the zipper is opened), the first portion 1002 is at least partially removed from the second portion 1004.

To further illustrate the coupling and decoupling of near field and far field components of an RFID device in accordance with some embodiment, reference is made to FIGS. 13A-13B. In FIG. 13A, a near field RFID tag 1302 is illustrated including an integrated circuit or chip 1320 coupled to a near field antenna 1322 (e.g., loop antenna) and including elongated conductors 1324 and 1326 that allow the near field antenna 1322 to be coupled to a conductive element 1308 that functions as a far field antenna. In FIG. 13A, the conductor 1326 is capacitively coupled to the conductive element 1308.

In operation, each of the conductors 1324 and 1326 can function as a first electrode of a capacitor formed between itself and a far field or tag antenna, where a portion of the far field antenna forms the second electrode of the capacitor. Electromagnetic energy from the tag reader causes the voltage on the far field antenna (particularly at its end) to oscillate building a charge. This creates an oscillating potential difference at each elongated side of the near field RFID tag 1302, which causes a current to flow about the loop 1322. This flowing current allows the chip 1320 to operate and in turn, the conductive element 1308 functioning as the far field antenna capacitively coupled to the RFID tag 1302 to transmit an encoded backscattered signal to the tag reader.

In one embodiment, the near field RFID tag 1302 may be pre-manufactured. According to several embodiments, the near field RFID tag 1302 does not function as a far field RFID tag, i.e., on its own, it cannot be read in the far field by a reader. In preferred embodiments, the near field antenna 1322 is designed, shaped and/or configured to be suitable for use with a far field antenna capacitively coupled thereto. In some cases, the width or thickness of the conductors 1324 and 1326 is designed to ensure good capacitive coupling with the far field antenna.

The conductors 1324 and 1326 may extend from the near field antenna 1322 in a variety of ways and have varying lengths depending on the far field antenna it is intended to couple with. However, the coupling conductors 1324 and 1326 do not themselves function as far field antennas. Accordingly, while there is some additional conductive material apart from the near field antenna 1322, the near field RFID tag 1302 apart from a far field antenna is a near field only RFID tag that functions in the near field. For example, the conductors 1324 and 1326 cause the near field RFID tag 1302 to operate in the near field radiating sub-region 1204, whereas the near field antenna 1322 (e.g., loop) causes the near field RFID tag 1302 to operate in the near field reactive sub-region 1206.

When coupled with a far field antenna such as conductive element 1308, the resulting combination functions in both the near field and the far field. In some embodiments, to affect capacitive coupling, the near field RFID tag 1302 is coupled in a spaced relationship to one end 1304 of the conductive element 1308 (e.g., at a distal region 1310 of the conductive element as opposed to at or near the central region 1312). In operation, the voltage at the end 1304 (distal region 1310) oscillates due to the received electromagnetic energy from the reader. In some embodiments, the end 1304 and the conductor 1326 form two electrodes of a capacitor. As the voltage oscillates at the end 1304 building a charge, this creates an oscillating potential difference at the side of the tag 1302, which causes a current to flow about the near field antenna 1322. This flowing current allows the chip 1320 to operate and in turn, the conductive element 1308 capacitively coupled to the tag 1302 to transmit an encoded backscattered signal to the tag reader. When the end 1304 or distal region 1310 of the conductive element 1308 is capacitively coupled to the near field RFID tag 1302, the device becomes visible in the far field to an RFID reader.

As illustrated in FIG. 13B, when the near field RFID tag 1302 and the conductive element 1308 are moved relative to each other, the two components are decoupled, i.e., no longer capacitively coupled. Thus, the near field RFID tag 1302 is now only readable in the near field, not in the far field.

The near field RFID tag 1302 could be an embodiment of the first RFID tag 302 or 406, for example, and the conductive element may be an embodiment of conductive elements 308 and 408, for example. It is understood that while FIGS. 13A-13B illustrate the capacitive coupling of the near field RFID tag 1302 and the conductive element 1308, in other embodiments, the two components may be inductively or electrically coupled together such as described in the various patent documents incorporated herein by reference.

In some embodiments, an application of one or more embodiments of the methods and structures to determine an open status of a container may be used in a secure delivery application in order to determine and/or verify opening of a package intended for delivery to a recipient (person). For example, the container may be delivered and locked within a delivered-package vault such as described in U.S. patent application Ser. No. 14/052,102 filed Oct. 11, 2013 and entitled SECURE DELIVERY RECEPTACLE, which is incorporated herein by reference. In some embodiments, the container contains the package for delivery to an intended recipient. The container is stored in the delivered package vault and locked therein, such that the intended recipient is not required to be physically present to accept delivery of the package. Such package vault may contain one or more structures and methods to determine that the container with package has been placed within the vault. In some embodiments, the container is pre-located in the vault (or part of the vault) and the package is delivered to the vault and inserted into the container within the vault by the delivery person. In some embodiments, the vault includes an RFID reader configured to read tags in the far field of RFID operation. When an intended recipient accesses the package vault to retrieve the package from the container (e.g., at the recipient's convenience), one or more methods and/or apparatuses described herein may be used to determine the open status of the container. For example, the container includes a first RFID tag and the second RFID tag (and optional third or additional RFID tag/s) as variously described herein. If the first RFID tag is read by the vault's reader, the control circuit (coupled to the reader) can determine that the container is sealed/closed. However, once the first tag is no longer read by the reader, the control circuit can determine that the container is unsealed or that the container opening has been initiated or confirmed, for example. In some forms, the vault can distinguish a scenario where the first tag is not being read anymore because the container was moved from the vault out of range of the reader without opening the container (e.g., the container is fixed into the vault, opening size restriction, or there is another way (e.g., visual) to verify that the container is present in the vault). Once the second and optional third or more RFID tags are read by the reader (as they are exposed as described herein), the control circuit can determine one or more additional open status. Once the recipient has opened the container, the package may be retrieved therefrom, completing delivery. In some embodiments, measures can be taken to ensure that the right container has been opened by the right recipient. For example, by reader the various tags and using their identifiers, the control circuit can determine if the proper user (e.g., as determined at the point of access to the vault) has opened the proper container. If not, warning messages, emails, text messages or other electronic warnings may be issued to the appropriate system or person/s. In some embodiments, the container may be a refrigerated container or otherwise a container that requires sealing due to the package contained therein. Thus, in some embodiments, the reading or cessation of reading of the RFID tags can be used to determine an unsealed status. In the case of perishable packages (e.g., groceries, food items, refrigerated items, etc.), the control circuit (or other circuit or system in communication therewith) could start a timer and track whether the container has been fully opened within a specified time. For example, one could accidentally unseal a container but not open it fully, which would be detectable. In another example, someone may gain access to the vault and tamper with one or more containers, which could be detected in the opening/unsealing of the container. In some embodiments, since the first portion is flexible insert within a sleeve (second portion) and may even require an insertion tool, it would be difficult for one who tampered or accidentally unsealed a package to re-insert the first portion into the second portion. Corrective action could be taken or signaled to be taken, e.g., a warning message, refund of purchase, re-delivery of the item, etc. There are many alternatives and variations of these example applications that may use one or more embodiments of the methods and apparatuses described herein. It is understood that many other applications may use one or more embodiments of the methods and apparatuses described herein.

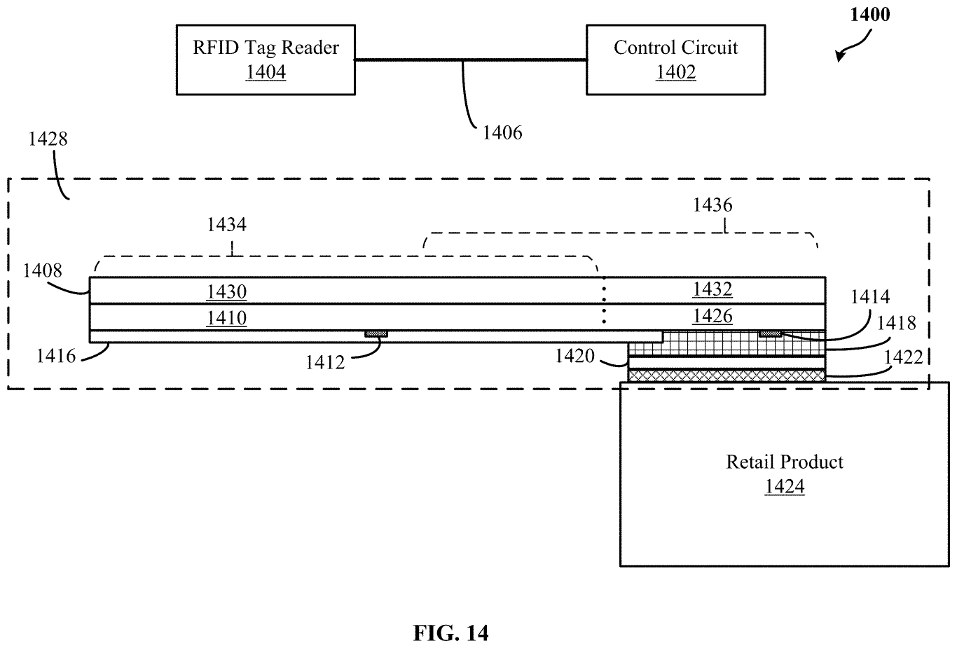

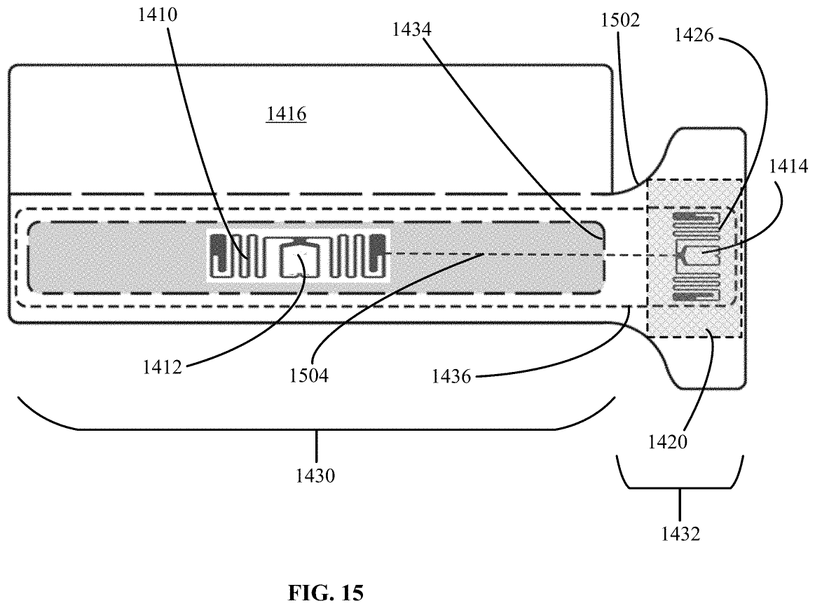

In an illustrative non-limiting example, FIG. 14 illustrates a simplified block diagram of an exemplary system 1400 illustrating an application using a multi-tag RFID device 1428 in accordance with several embodiments. For example, the system 1400 is shown using the multi-tag RFID device 1428 in detecting retail product label removal from products for sale at a retail facility. FIG. 15 is an illustrative non-limiting diagram of a multi-tag RFID device in accordance with several embodiments. By one approach, the system 1400 includes a product identifier including a base substrate 1408 having a first portion 1430 and a second portion 1432. For example, the base substrate 1408 may include plastic, metal, and/or other types of materials configured to function as a base substrate for RFID tag devices. In one configuration, the system 1400 may include a first radio-frequency identification (RFID) tag device 1434 located at the first portion 1430 of the base substrate 1408. By one approach, a first RFID tag device 1434 includes a first antenna portion 1410 and a first integrated circuit 1412 storing a first identifier corresponding to a first retail product 1424.

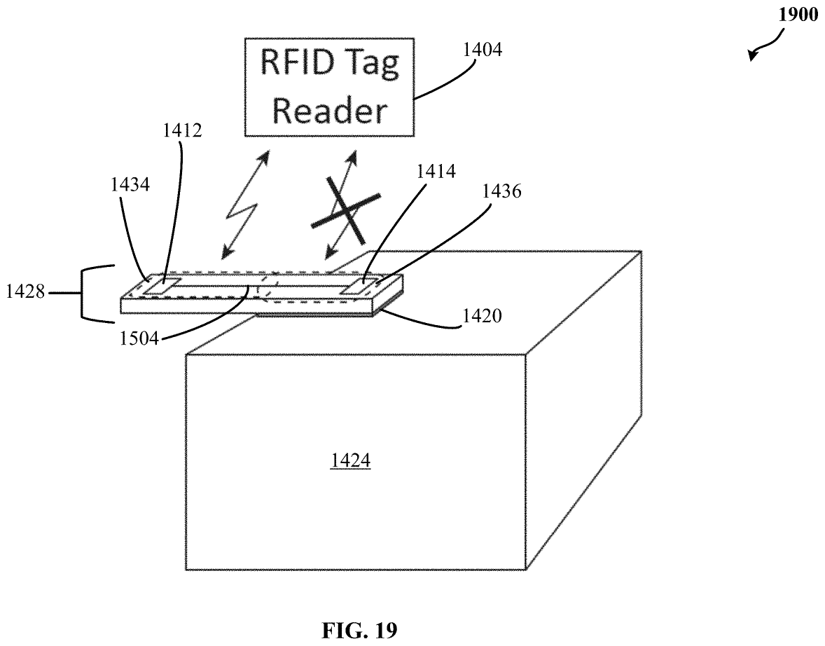

In some implementations, the system 1400 may include a second RFID tag device 1436 located at the second portion 1432 of the base substrate 1408. By one approach, the second RFID tag device 1436 may include a second antenna portion 1426 and a second integrated circuit 1414 storing a second identifier. For example, the first and second integrated circuits 1412, 1414 may include a microchip, an integrated circuit, and/or a unit of packaged computer circuitry/integrated circuit that may be manufactured from a material (e.g., silicon) at a very small scale. By one approach, the first and second integrated circuits 1412, 1414 may include program logic and/or computer memory (e.g., memory, random access memory, and/or the like) configured to store identifiers, receive one or more signals (e.g., data signal, energy signal, frequency signal, and/or the like) from the RFID tag reader 1404, provide identifiers and/or signals (e.g., data signal, energy signal, frequency signal, and/or the like) to the RFID tag reader 1404, and/or receive programming, etc. In one configuration, the first and second antenna portions 1410, 1426 may be configured to receive and/or transmit one or more radio frequency signals. For example, the one or more radio frequency signals may include Low Frequency (LF), High Frequency (HF), Near-Field Communication (NFC), and/or Ultra High Frequency (UHF), among other types of radio frequency signals. In some embodiments, the first antenna portion 1410 and the second antenna portion 1426 may include a single antenna structure 1504 shared by the first integrated circuit 1412 and the second integrated circuit 1414, as shown in FIGS. 15 and 19. For example, at least a layer of conductive material (e.g., copper, aluminum, and/or other types of materials capable of receiving and/or transmitting RFID signals) may include the single antenna structure 1504, the first antenna portion 1410, and the second antenna portion 1426. In some embodiments, the first antenna portion 1410 and the second antenna portion 1426 may each include separate antenna structures not shared by the first integrated circuit 1412 and the second integrated circuit 1414.

Alternatively or in addition to, the system 1400 may include a metallic substrate 1420. For example, the metallic substrate 1420 may include aluminum, copper, tin, and/or gold, among other types of conductive materials. In an illustrative non-limiting example, FIG. 15 illustrates an embodiment of the multi-tag RFID device 1428 showing the first integrated circuit 1412, the second integrated circuit 1414, the metallic substrate 1420, a flap 1416, a first RFID tag device 1434, a second RFID tag device 1436. Those skilled in the art will recognize that a wide variety of other modifications, alterations, and combinations can also be made with respect to the embodiment shown in FIG. 15 without departing from the scope of the invention, and that such modifications, alterations, and combinations are to be viewed as being within the ambit of the inventive concept. In some implementations, the metallic substrate 1420 may overlap the second antenna portion 1426 and/or the second integrated circuit 1414, as shown in FIG. 15. In such an implementation, a Near-Field RFID tag reader may read, communicate with, encode, and/or program the second integrated circuit 1414. For example, the second integrated circuit 1414 may be programmed by a Near-Field RFID tag reader even though the metallic substrate 1420 may be coupled to at least a portion of the second RFID tag device 1436. In one illustrative non-limiting example, the metallic substrate 1420 may overlap and/or cover the second portion 1432 of the base substrate 1408 of the multi-tag RFID device 1428. However, a Far-Field RFID tag reader (e.g., an RFID Tag Reader 1404) may not be able to read, communicate with, encode, and/or program the second integrated circuit 1414 as long as the metallic substrate 1420 overlaps and/or is coupled to the second antenna portion 1426 and/or the second integrated circuit 1414. In one scenario where the second RFID tag device 1436, the second antenna portion 1426, and/or the second integrated circuit 1414 is detached and/or decoupled (e.g., by an application of a separation force causing the first attachment mechanism 1418 to fail) from the metallic substrate 1420, the Far-Field RFID tag reader may then read, communicate with, encode, and/or program the second integrated circuit 1414. In some embodiments, a substantial portion of the first RFID tag device 1434 may include the first antenna portion 1410. In yet some embodiments, a portion of the first RFID tag device 1434 may include the first antenna portion 1410. Alternatively or in addition to, a substantial portion of the second RFID tag device 1436 may include the second antenna portion 1426. In yet some embodiments, a portion of the second RFID tag device 1436 may include the second antenna portion 1426. In yet other embodiments, the metallic substrate 1420 may overlap the portion of the second RFID tag device 1436 including the second antenna portion 1426 and/or the second integrated circuit 1414.

Alternatively or in addition to, the flap 1416 may cover at least the first portion 1430 of the base substrate 1408. In such an example, the first integrated circuit 1412 and at least the first antenna portion 1410 may be covered by the flap 1416. By one approach, the flap 1416 may include a thermoplastic material and/or any materials that are not conductive. For example, the flap 1416 may provide protection from the environments (e.g., air, dust, other objects, users, etc.) the multi-tag RFID device 1428 may be subjected to, surrounded by, and/or immersed in. In some configurations, the first portion 1430 of the base substrate 1408 is longer in length relative to the second portion of the base substrate. For example, the first portion 1430 and the second portion 1432 form an arc 1502 at a junction point to substantially keep the first portion 1430 from being detached from the second portion 1432, as shown in FIG. 15.

Alternatively or in addition to, the system 1400 may include a first attachment mechanism 1418 disposed on a first portion of the metallic substrate 1420. By one approach, the first attachment mechanism 1418 may detachably couple the metallic substrate 1420 to and/or cover at least a portion of the second portion 1432 of the base substrate 1408 including the second integrated circuit 1414. For example, the metallic substrate 1420 may cover at least the second integrated circuit 1414 and electromagnetically shields the second integrated circuit 1414 such that the second RFID tag device 1436 is not readable by an RFID tag reader 1404. By one approach, the metallic substrate 1420 may create a path to ground such that signals transmitted by the RFID tag reader 1404 and/or received by the second antenna portion 1426 do not cause the second integrated circuit 1414 to be operational. In some configurations, the metallic substrate 1420 does not cover at least a portion of the first portion 1430 of the base substrate 1408 including the first integrated circuit 1412 such that the first RFID tag device 1434 is readable by the RFID tag reader 1404. For example, when the multi-tag RFID device 1428 is within a threshold distance from the RFID tag reader 1404, the first antenna portion 1410 of the first RFID tag device 1434 may receive the signals transmitted by the RFID tag reader 1404. As such, the first integrated circuit 1412 may become operational. By one approach, the first integrated circuit 1412 may provide the first identifier corresponding to the first retail product 1424. In some implementations, when the metallic substrate 1420 covers at least the second integrated circuit 1414, the second identifier stored in the second integrated circuit 1414 is not readable by the RFID tag reader 1404.

In other implementations, when the metallic substrate 1420 is detached and/or at least partially detached from the second integrated circuit 1414, the second identifier becomes readable by the RFID tag reader 1404. For example, the system 1400 may include a second attachment mechanism 1422 disposed on a second portion of the metallic substrate 1420. For example, the second attachment mechanism 1422 may detachably couple the metallic substrate 1420 to at least a portion of the first retail product 1424. In one scenario, the first attachment mechanism 1418 may fail with the application of a lower separation force than the second attachment mechanism 1422, such that upon an action causing a separation force to separate the base substrate 1408 from the first retail product 1424 causes the first attachment mechanism 1418 to fail such that the base substrate 1408 will be removed from the metallic substrate 1420 and the first retail product 1424. For example, upon this separation and removal, the second RFID tag device 1436 may then be readable by the RFID tag reader 1404. By one approach, the first and second attachment mechanisms 1418, 1422 may include adhesive layers. For example, one or more adhesive layers may include epoxies, polyurethanes, polyimides, glues, and/or various plastic agents that bond by evaporation of a solvent or by curing a bonding agent with heat, pressure, and/or time.

In some embodiments, the second attachment mechanism 1422 may be detachably connecting the metallic substrate 1420 to the first retail product 1424. In such embodiments, the first attachment mechanism 1418 may be configured to create a weaker bond between the metallic substrate 1420 and the base substrate 1408 relative to the bond created by the second attachment mechanism 1422 between the metallic substrate 1420 and the first retail product 1424. As such, an application of a lower separation force may cause a separation force to separate the base substrate 1408 from the first retail product 1424 causing the first attachment mechanism 1418 to fail such that the base substrate 1408 will be removed from the metallic substrate 1420 and the first retail product 1424, thereby, causing the second RFID tag device 1436 to be readable by the RFID tag reader 1404. By one approach, a reading of the second RFID tag device 1436 by the RFID tag reader 1404 may indicate that the product identifier has been removed from the first retail product 1424.

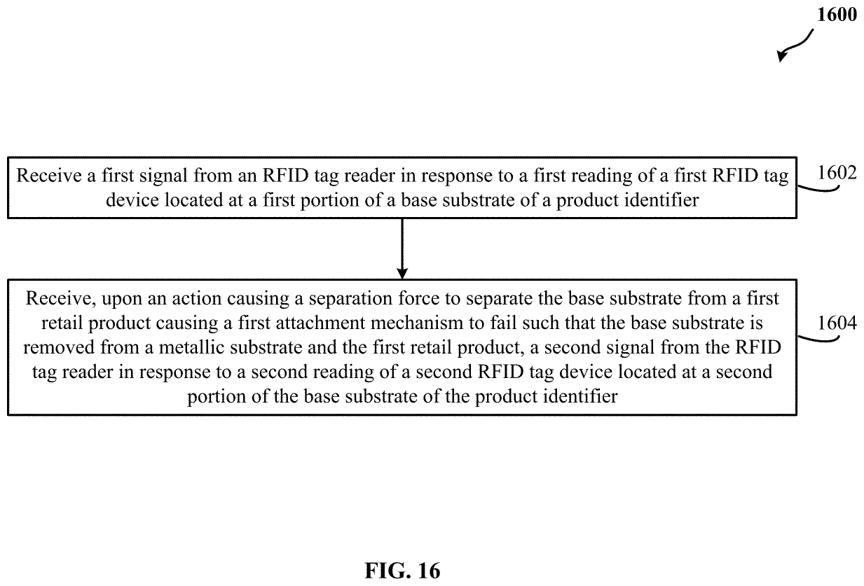

To further illustrate, FIG. 16 is a flow diagram of a method 1600 in accordance with several embodiments, is shown. Alternatively or in addition to, the system 1400 may include a control circuit 1402. In one configuration, the control circuit 1402 may couple to the RFID tag reader 1404 via a communication network 1406. For example, the communication network 1406 may include a wired and/or a wireless network, Internet, a WIFI, and/or a local area network, among other types of wired and/or wireless network implemented via privately and/or publicly known communication protocols. By one approach, the control circuit 1402 may, at step 1602, receive a first signal from the RFID tag reader 1404 in response to a first reading of the first RFID tag device 1434 located at the first portion 1430 of the base substrate 1408 of a product identifier stored by the first integrated circuit 1412. In one configuration, the control circuit 1402 may, at step 1604, receive a second signal from the RFID tag reader 1404 in response to a second reading of the second RFID tag device 1436 located at the second portion 1432 of the base substrate 1408 of the multi-tag RFID device 1428 and/or a product identifier. By one approach, the receipt of the second may be upon and/or in response to an action causing a separation force to separate the base substrate 1408 from a retail product 1424 that causes the first attachment mechanism 1418 to fail such that the base substrate 1408 is removed from the metallic substrate 1420 and the retail product 1424. Alternatively or in addition to, in response to the receipt of the signal, the control circuit 1402 may provide an alarm signal to an associate, an alarm device, and/or a portable electronic device.

In an illustrative non-limiting example, the multi-tag RFID device 1428 may be attached to the retail product 124 located on a shelf of a rack storing at least retail product 124. In one scenario, the metallic substrate 1420 may be inadvertently detached from the base substrate 1408, that is, the adhesion bond created by the first attachment mechanism 1418 failed causing the metallic substrate 1420 to be detached from the base substrate 1408. In response, the second RFID tag device 1436 may become readable by the RFID tag reader 1404. As such, the second identifier stored by the second integrated circuit 1414 may be read by the RFID tag reader 1404. In one configuration, the second identifier may be derived from the first identifier stored by the first integrated circuit 1412. In another configuration, the second identifier may be derived from the first identifier by one or more of the following ways: the second identifier is a binary compliment of the first identifier or the second identifier is a compressed data representation of the first identifier. In another configuration, the second identifier may include a manufacturer assigned identifier associated with the second integrated circuit 1414.

In such a configuration, upon a reading of the second identifier, the control circuit 1402 may access a database including associations of each of a plurality of manufacturer assigned identifiers with each of a plurality of first identifiers, for example, the first identifier may include a Universal Product Code (UPC) data. By one approach, the control circuit 1402 may determine that the multi-tag RFID device 1428 may have been removed from a particular retail product 1424 based on a matching of the manufacturer assigned identifier associated with the second integrated circuit 1414 of the multi-tag RFID device 1428 with the UPC data associated with the particular retail product 1424 that was read by the RFID tag reader 1404 from the first integrated circuit 1412. In such a scenario, the control circuit 1402 may cause an alarm device to sound and/or an alarm signal sent to a portable electronic device (e.g., smartphone, table, smartwatch, laptop, iPad, and/or the like) associated with an associate. Alternatively or in addition to, the control circuit 1402 may initiate capture and/or storage of one or more images captured by one or more cameras located in a location associated with the RFID tag reader 1404 that read the second RFID tag device 1436. For example applications and/or implementations of the system 1400 may include in product theft prevention, asset tracking management, inventory, etc.

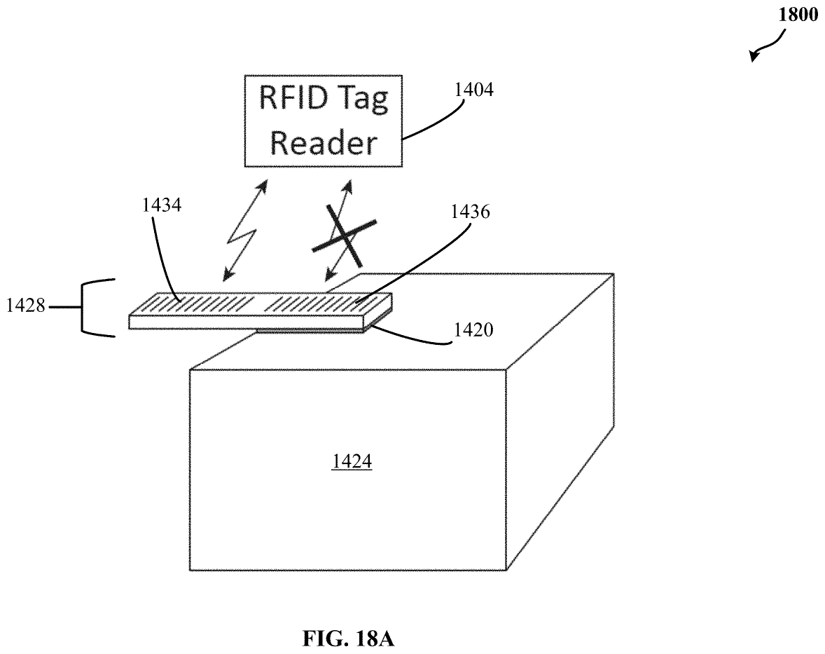

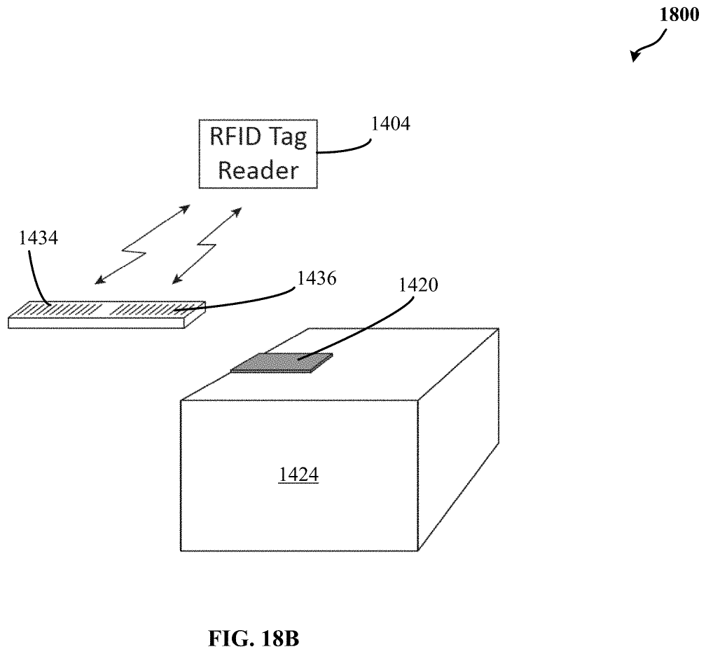

To further illustrate, FIGS. 18A, 18B, and 19 are described below. FIG. 18A-18B illustrates a simplified block diagram of an exemplary system 1800 illustrating an application using a multi-tag RFID device in accordance with several embodiments. FIG. 19 illustrates a simplified block diagram of an exemplary system 1900 illustrating an application using a multi-tag RFID device in accordance with several embodiments. By one approach, FIG. 18A illustrates the multi-tag RFID device 1428 being attached to the retail product 1424. In such an approach, the metallic substrate 1420 is disposed between the retail product 1424 and the second RFID tag device 1436. As such, the RFID tag reader 1404 may read the first RFID tag device 1434 and not read the second RFID tag device 1436. In one scenario, as illustrated in FIG. 18B, the multi-tag RFID device 1428 may be detached from the metallic substrate 1420. In response to the multi-tag RFID device 1428 being detached from the metallic substrate 1420 and the product 1424, the RFID tag reader 1404 may read both the first RFID tag device 1434 and the second RFID tag device 1436. In some embodiments, as illustrated in FIG. 19, the first antenna portion 1410 and the second antenna portion 1426 may include a single antenna structure 1504 shared by the first integrated circuit 1412 and the second integrated circuit 1414. In such embodiments, a first portion of the first RFID tag device 1434 may overlap with a second portion of the second RFID tag device 1436. In some scenarios, the multi-tag RFID device 1428 may be detached from the metallic substrate 1420. In response to the multi-tag RFID device 1428 being detached from the metallic substrate 1420, the RFID tag reader 1404 may then also read the second RFID tag device 1436 and/or the second integrated circuit 1414. It is understood that in some embodiments, the first RFID tag device 1434 and the second RFID tag device 1436 have separate and independent antenna structures instead of a shared antenna structure as illustrated in FIG. 19.

In accordance with some embodiments, the systems and methods described herein can be useful when the retail product 1424 has inherent dielectric properties that make it difficult for an RFID tag applied directly thereto to be read by an RFID tag reader. For example, the retail product 1424 has certain metallic content or chemical composition that interfere with the ability to read the product tag. In such case, it can be desirable to locate the multi-tag RFID device 1428 such that it hangs or extends away from the retail product 1424. In the example of FIGS. 18A-19, the first RFID tag device 1434 is the RFID tag that is encoded with the relevant product identifiers. As positioned in FIGS. 18A and 19, the first RFID tag device 1434 extends away from the retail product 1424 such that the first RFID tag device 1434 can be easily read. However, having an RFID tag physically extending away from the retail product 1424 may make it more susceptible to being removed from the retail product 1424, e.g., intentionally removed by one aiming to steal the retail product 1424, removed accidentally through physical contact with other objects, and so on. As such, in an illustrative non-limiting example, the arc 1502 at a junction point between the first portion 1430 and the second portion 1432, as shown in FIG. 15, may substantially keep the first portion 1430 from being detached from the second portion 1432, thereby, making the multi-tag RFID device 1428 not susceptible to being removed from the retail product 1424. Additionally, in another illustrative non-limiting example, configuring the first attachment mechanism 1418 to have a lower separation force than the second attachment mechanism 1422 enables the second RFID tag device 1436 to be read by the RFID tag reader 1404 when the multi-tag RFID device 1428 is detached and/or separated from the retail product 1424. In such example, the metallic substrate 1420 remain attached to the retail product 1424 while the second RFID tag device 1436 is detached from the retail product 1424, thereby allowing the encoded identifier in the second integrated circuit 1414 to be read by the RFID tag reader 1404. In some implementations, the RFID tag reader 1404 may include a Far-Field RFID reader. By one approach, to be able to detect the removal of the multi-tag RFID device 1428, the second RFID tag 1436 is positioned proximate to the metallic substrate 1420 so that it can only be read when the multi-tag RFID device 1428 is detached. The fact that the second RFID tag device 1436 is read is an indicator that the multi-tag RFID device 1428 has become detached from the retail product 1424. The encoding of the second RFID tag device 1436 can be used to help uniquely identify the retail product 1424. For example, the second RFID tag device 1436 can be encoded with a second identifier that is derived from a first identifier encoded in the first RFID tag device 1434 by one or more of the following ways: the second identifier is a binary compliment of the first identifier or the second identifier is a compressed data representation of the first identifier. In another example, the second RFID tag device 1436 may be encoded with a manufacturer assigned identifier associated with the second integrated circuit 1414 while a Universal Product Code (UPC) data is encoded in the first RFID tag device 1434. As such, a database in communication with the control circuit 1402 may store a plurality of associations between a plurality of UPC data and a plurality of manufacturer assigned identifiers. In one configuration, the control circuit 1402 may access the database to determine which UPC data is associated with a manufacturer assigned identifier read by the RFID tag reader 1404. In response to the determination of the association of the UPC data with the manufacturer assigned identifier, the control circuit 1402 may then determine the retail product 1424 that had its multi-tag RFID device 1428 detached based on the association of the UPC data with the manufacturer assigned identifier read.

FIGS. 14, 15, 17, 18A, 18B, and 19 are not necessarily drawn to scale. As such, various components and/or elements of the figures may appear the same, smaller, bigger, wider, and/or longer relative to the other components and/or elements of the figures. Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

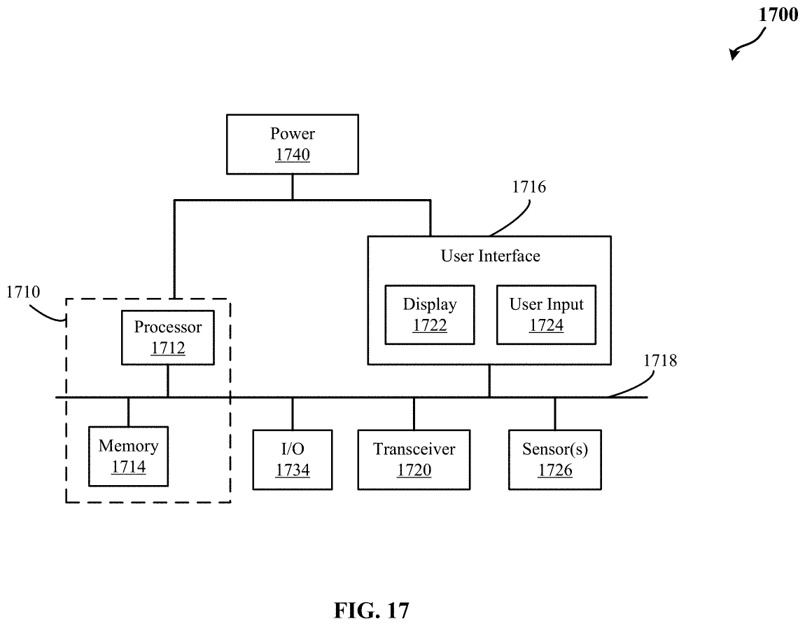

Further, the circuits, circuitry, systems, devices, processes, methods, techniques, functionality, services, servers, sources and the like described herein may be utilized, implemented and/or run on many different types of devices and/or systems. FIG. 17 illustrates an exemplary system 1700 that may be used for implementing any of the components, circuits, circuitry, systems, functionality, apparatuses, processes, or devices of the system 1400 of FIG. 14, the method 1600 of FIG. 16, the multi-tag RFID devices 1428 of FIGS. 15, 18A-18B, 19, and/or other above or below mentioned systems or devices, or parts of such circuits, circuitry, functionality, systems, apparatuses, processes, or devices. For example, the system 1700 may be used to implement some or all of the system for detecting retail product label removal from products for sale at a retail facility, the RFID tag reader 1404, the control circuit 1402, and/or other such components, circuitry, functionality and/or devices. However, the use of the system 1700 or any portion thereof is certainly not required.

By way of example, the system 1700 may comprise a processor module (or a control circuit) 1712, memory 1714, and one or more communication links, paths, buses or the like 1718. Some embodiments may include one or more user interfaces 1716, and/or one or more internal and/or external power sources or supplies 1740. The control circuit 1712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1712 can be part of control circuitry and/or a control system 1710, which may be implemented through one or more processors with access to one or more memory 1714 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1700 may be used to implement one or more of the above or below, or parts of, components, circuits, systems, processes and the like. For example, the system 1700 may implement the system for detecting retail product label removal from products for sale at a retail facility with the control circuit 1402 being the control circuit 1712.

The user interface 1716 can allow a user to interact with the system 1700 and receive information through the system. In some instances, the user interface 1716 includes a display 1722 and/or one or more user inputs 1724, such as buttons, touch screen, track ball, keyboard, mouse, etc., which can be part of or wired or wirelessly coupled with the system 1700. Typically, the system 1700 further includes one or more communication interfaces, ports, transceivers 1720 and the like allowing the system 1700 to communicate over a communication bus, a distributed computer and/or communication network (e.g., a local area network (LAN), the Internet, wide area network (WAN), etc.), communication link 1718, other networks or communication channels with other devices and/or other such communications or combination of two or more of such communication methods. Further the transceiver 1720 can be configured for wired, wireless, optical, fiber optical cable, satellite, or other such communication configurations or combinations of two or more of such communications. Some embodiments include one or more input/output (I/O) interface 1734 that allow one or more devices to couple with the system 1700. The I/O interface can be substantially any relevant port or combinations of ports, such as but not limited to USB, Ethernet, or other such ports. The I/O interface 1734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1726 to provide information to the system and/or sensor information that is communicated to another component, such as the control circuit 1402, the RFID tag reader 1404, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1700 comprises an example of a control and/or processor-based system with the control circuit 1712. Again, the control circuit 1712 can be implemented through one or more processors, controllers, central processing units, logic, software and the like. Further, in some implementations the control circuit 1712 may provide multiprocessor functionality.

The memory 1714, which can be accessed by the control circuit 1712, typically includes one or more processor readable and/or computer readable media accessed by at least the control circuit 1712, and can include volatile and/or nonvolatile media, such as RAM, ROM, EEPROM, flash memory and/or other memory technology. Further, the memory 1714 is shown as internal to the control system 1710; however, the memory 1714 can be internal, external or a combination of internal and external memory. Similarly, some or all of the memory 1714 can be internal, external or a combination of internal and external memory of the control circuit 1712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 1714 can store code, software, executables, scripts, data, content, lists, programming, programs, log or history data, user information, customer information, product information, and the like. While FIG. 17 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for use in detecting retail product label removal from products for sale at a retail facility, the system comprising:
a product identifier comprising a base substrate having a first portion and a second portion;
a first radio-frequency identification (RFID) tag device located at the first portion of the base substrate, the first RFID tag device comprising:
a first antenna portion; and
a first integrated circuit storing a first identifier corresponding to a first retail product:
a second radio-frequency identification (RFID) tag device located at the second portion of the base substrate, the second RFID tag device comprising:
a second antenna portion; and
a second integrated circuit storing a second identifier;
a metallic substrate;
a first attachment mechanism disposed on a first portion of the metallic substrate, the first attachment mechanism detachably coupling the metallic substrate to and covering at least a portion of the second portion of the base substrate including the second integrated circuit, wherein the metallic substrate covers at least the second integrated circuit and electromagnetically shields the second integrated circuit such that the second RFID tag device is not readable by an RFID tag reader, wherein the metallic substrate does not cover at least a portion of the first portion of the base substrate including the first integrated circuit such that the first RFID tag device is readable by the RFID tag reader; and
a second attachment mechanism disposed on a second portion of the metallic substrate, the second attachment mechanism configured to detachably couple the metallic substrate to at least a portion of the first retail product;
wherein the first attachment mechanism is configured to fail with an application of a lower separation force than the second attachment mechanism, such that upon an action causing a separation force to separate the base substrate from the first retail product will cause the first attachment mechanism to fail such that the base substrate will be removed from the metallic substrate and the first retail product, wherein upon this separation and removal, the second RFID tag device will then be readable by the RFID tag reader.

2. The system of claim 1, further comprising the first retail product, wherein the second attachment mechanism is detachably connecting the metallic substrate to the first retail product.

3. The system of claim 1, wherein a reading of the second RFID tag device by the RFID tag reader indicates that the product identifier has been removed from the first retail product.

4. The system of claim 3, further comprising a control circuit coupled to the RFID tag reader, wherein the control circuit is configured to:
receive a signal from the RFID tag reader in response to the reading of the second RFID tag device;
in response to the receipt of the signal, provide an alarm signal to at least one of: an associate, an alarm device, and a portable electronic device.

5. The system of claim 1, wherein the first and second attachment mechanisms comprise adhesive layers.

6. The system of claim 1, wherein the first antenna portion and the second antenna portion comprise a single antenna structure shared by the first integrated circuit and the second integrated circuit.

7. The system of claim 1, wherein the first antenna portion and the second antenna portion each comprise separate antenna structures not shared by the first integrated circuit and the second integrated circuit.

8. The system of claim 1, wherein the second identifier is derived from the first identifier.

9. The system of claim 1, wherein the second identifier is derived from the first identifier by one or more of the following ways: the second identifier is a binary compliment of the first identifier or the second identifier is a compressed data representation of the first identifier.

10. The system of claim 1, wherein the second identifier comprises a manufacturer assigned identifier associated with the second integrated circuit, and wherein the first identifier comprises a Universal Product Code (UPC) data.

11. The system of claim 1, further comprising a flap covering at least the first portion of the base substrate, wherein the first integrated circuit and at least the first antenna portion are covered by the flap.

12. The system of claim 11, wherein the flap comprises a thermoplastic material.

13. The system of claim 1, wherein the first portion of the base substrate is longer in length relative to the second portion of the base substrate, and wherein the first portion and the second portion form an arc at a junction point to substantially keep the first portion from being detached from the second portion.

14. The system of claim 1, wherein the second identifier is readable by a Near-Field RFID tag reader and not readable by a Far-Field RFID tag reader when the metallic substrate is coupled to the second RFID tag device via the first attachment mechanism and covers at least the portion of the second portion of the base substrate including the second antenna portion.

15. A method for use in detecting retail product label removal from products for sale at a retail facility, the method comprising:
by a control circuit that is operably coupled to a radio frequency identification (RFID) tag reader:
receiving a first signal from the RFID tag reader in response to a first reading of a first RFID tag device located at a first portion of a base substrate of a product identifier, the first RFID tag device comprising:
a first antenna portion;
a first integrated circuit storing a first identifier corresponding to a first retail product; and
the product identifier further comprises a second portion, wherein a first attachment mechanism covers at least a portion of the second portion of the base substrate including a second integrated circuit and is disposed on a first portion of a metallic substrate, wherein the first attachment mechanism is configured to fail with an application of a lower separation force than a second attachment mechanism disposed on a second portion of the metallic substrate coupled to the first retail product, such that upon an action causing a separation force to separate the base substrate from the first retail product will cause the first attachment mechanism to fail such that the base substrate will be removed from the metallic substrate and the first retail product, and wherein upon this separation and removal, a second RFID tag device will then be readable by the RFID tag reader; and
receiving, upon an action causing a separation force to separate the base substrate from the first retail product causing the first attachment mechanism to fail such that the base substrate is removed from the metallic substrate and the first retail product, a second signal from the RFID tag reader in response to a second reading of the second RFID tag device located at the second portion of the base substrate of the product identifier, the second RFID tag device comprising:
a second antenna portion; and
the second integrated circuit storing a second identifier, wherein the metallic substrate covers at least the second integrated circuit and electromagnetically shields the second integrated circuit such that the second RFID tag device is not readable by the RFID tag reader, and wherein the metallic substrate does not cover at least a portion of the first portion of the base substrate including the first integrated circuit such that the first RFID tag device is readable by the RFID tag reader.

16. The method of claim 15, further comprising providing an alarm signal to at least one of: an associate, an alarm device, and a portable electronic device in response to the receipt of the second signal.

17. The method of claim 15, wherein the second reading of the second RFID tag device by the RFID tag reader indicates that the product identifier has been removed from the first retail product.

18. The method of claim 15, wherein the first and second attachment mechanisms comprise adhesive layers.

19. The method of claim 15, wherein the first antenna portion and the second antenna portion comprise a single antenna structure shared by the first integrated circuit and the second integrated circuit.

20. The method of claim 15, wherein the first antenna portion and the second antenna portion each comprise separate antenna structures not shared by the first integrated circuit and the second integrated circuit.

21. The method of claim 15, wherein the second identifier is derived from the first identifier.

22. The method of claim 15, wherein the second identifier is derived from the first identifier by one or more of the following ways: the second identifier is a binary compliment representation of the first identifier or the second identifier is a compressed data representation of the first identifier.

23. The method of claim 15, wherein the second identifier comprises a manufacturer assigned identifier associated with the second integrated circuit, and wherein the first identifier comprises a Universal Product Code (UPC) data.

24. The method of claim 15, wherein the first portion of the base substrate is longer in length relative to the second portion of the base substrate, and wherein the first portion and the second portion form an arc at a junction point to substantially keep the first portion from being detached from the second portion.

25. The method of claim 15, further comprising:
receiving, at a second control circuit that is operably coupled to a Near-Field RFID tag reader, a third signal from the Near-Field RFID tag reader in response to a third reading of the second RFID tag device when the metallic substrate is coupled to the second RFID tag device via the first attachment mechanism and covers at least the portion of the second portion of the base substrate including the second antenna portion, wherein the RFID tag reader coupled to the control circuit comprises a Far-Field RFID tag reader, and wherein the Far-Field RFID tag reader is unable to read the second RFID tag device when the metallic substrate is coupled to the second RFID tag device via the first attachment mechanism and covers at least the portion of the second portion of the base substrate including the second antenna portion.
